(19) United States
(12) Patent Application Publication
(10) Pub. No.: US 2022/0046624 A1
(43) Pub. Date: Feb. 10, 2022

(54) BEAM-BASED INITIAL TRANSMISSIONS, RE-TRANSMISSIONS, AND SEARCH SPACES

(71) Applicant: QUALCOMM Incorporated, San Diego, CA (US)

(72) Inventors: Kazuki TAKEDA, Tokyo (JP); Alberto RICO ALVARINO, San Diego, CA (US); Le LIU, Fremont, CA (US); Xipeng ZHU, San Diego, CA (US); Prasad Reddy KADIRI, San Diego, CA (US); Umesh PHUYAL, San Diego, CA (US)

(21) Appl. No.: 17/444,306

(22) Filed: Aug. 3, 2021

Related U.S. Application Data
(60) Provisional application No. 62/706,246, filed on Aug. 6, 2020.
(60) Provisional application No. 62/706,247, filed on Aug. 6, 2020.

(51) Int. Cl. H04W 72/04; H04L 1/18; H04W 72/08

(52) U.S. Cl. CPC H04W 72/046; H04W 72/08; H04L 1/189; H04W 72/042

(57) ABSTRACT

Various aspects of the present disclosure generally relate to wireless communication. In some aspects, a user equipment (UE) may receive, from a base station, an indication of a first search space for control messages from the base station, an indication of a first downlink beam for the first search space, an indication of a second search space for control messages from the base station, and an indication of a second downlink beam for the second search space. The UE may monitor the first search space, using a spatial filter based at least in part on the first downlink beam, for an initial transmission of data from the base station. Additionally, the UE may monitor the second search space, using a spatial filter based at least in part on the second downlink beam, for re-transmission of the data from the base station. Numerous other aspects are provided.

### CROSS-REFERENCE TO RELATED APPLICATIONS

This patent application claims priority to U.S. Provisional Patent Application No. 62/706,246, filed on Aug. 6, 2020, entitled “BEAM-BASED INITIAL TRANSMISSIONS AND RE-TRANSMISSIONS,” and assigned to the assignee hereof, and to U.S. Provisional Application No. 62/706,247, filed on Aug. 6, 2020, entitled “BEAM AND SEARCH SPACE CORRESPONDENCE FOR DOWNLINK TRANSMISSIONS,” and assigned to the assignee hereof. The disclosures of the prior applications are considered part of and is incorporated by reference in this patent application.

### FIELD OF THE DISCLOSURE

Aspects of the present disclosure generally relate to wireless communication and to techniques and apparatuses for beam-based initial transmission and re-transmissions, and for beam and search space correspondence for downlink transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. NR, which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving, from a base station, an indication of a first search space for control messages from the base station and an indication of a first downlink beam for the first search space; receiving, from the base station, an indication of a second search space for control messages from the base station and an indication of a second downlink beam for the second search space; monitoring the first search space, using a spatial filter based at least in part on the first downlink beam, for an initial transmission of data from the base station; and monitoring the second search space, using a spatial filter based at least in part on the second downlink beam, for re-transmission of the data from the base station.

In some aspects, a method of wireless communication performed by a base station includes transmitting, to a UE, an indication of a first search space for control messages from the base station and an indication of a first downlink beam for the first search space; transmitting, to the UE, an indication of a second search space for control messages from the base station and an indication of a second downlink beam for the second search space; sending an initial transmission of data within the first search space and using the first downlink beam; and sending a re-transmission of the data within the second search space and using the second downlink beam.

In some aspects, an apparatus for wireless communication at a UE includes a memory and one or more processors, coupled to the memory, configured to receive, from a base station, an indication of a first search space for control messages from the base station and an indication of a first downlink beam for the first search space; receive, from the base station, an indication of a second search space for control messages from the base station and an indication of a second downlink beam for the second search space; monitor the first search space, using a spatial filter based at least in part on the first downlink beam, for an initial transmission of data from the base station; and monitor the second search space, using a spatial filter based at least in part on the second downlink beam, for re-transmission of the data from the base station.

In some aspects, an apparatus for wireless communication at a base station includes a memory and one or more processors, coupled to the memory, configured to transmit, to a UE, an indication of a first search space for control messages from the base station and an indication of a first downlink beam for the first search space; transmit, to the UE, an indication of a second search space for control messages from the base station and an indication of a second downlink beam for the second search space; send an initial transmission of data within the first search space and using the first downlink beam; and send a re-transmission of the data within the second search space and using the second downlink beam.

In some aspects, a non-transitory computer-readable medium storing a set of instructions for wireless communication includes one or more instructions that, when executed by one or more processors of a UE, cause the UE to receive, from a base station, an indication of a first search space for control messages from the base station and an indication of a first downlink beam for the first search space; receive, from the base station, an indication of a second search space for control messages from the base station and an indication of a second downlink beam for the second search space; monitor the first search space, using a spatial filter based at least in part on the first downlink beam, for an initial transmission of data from the base station; and monitor the second search space, using a spatial filter based at least in part on the second downlink beam, for re-transmission of the data from the base station.

In some aspects, a non-transitory computer-readable medium storing a set of instructions for wireless communication includes one or more instructions that, when executed by one or more processors of a base station, cause the base station to transmit, to a UE, an indication of a first search space for control messages from the base station and an indication of a first downlink beam for the first search space; transmit, to the UE, an indication of a second search space for control messages from the base station and an indication of a second downlink beam for the second search space; send an initial transmission of data within the first search space and using the first downlink beam; and send a re-transmission of the data within the second search space and using the second downlink beam.

In some aspects, an apparatus for wireless communication includes means for receiving, from a base station, an indication of a first search space for control messages from the base station and an indication of a first downlink beam for the first search space; means for receiving, from the base station, an indication of a second search space for control messages from the base station and an indication of a second downlink beam for the second search space; means for monitoring the first search space, using a spatial filter based at least in part on the first downlink beam, for an initial transmission of data from the base station; and means for monitoring the second search space, using a spatial filter based at least in part on the second downlink beam, for re-transmission of the data from the base station.

In some aspects, an apparatus for wireless communication includes means for transmitting, to a UE, an indication of a first search space for control messages from the apparatus and an indication of a first downlink beam for the first search space; means for transmitting, to the UE, an indication of a second search space for control messages from the apparatus and an indication of a second downlink beam for the second search space; means for sending an initial transmission of data within the first search space and using the first downlink beam; and means for sending a re-transmission of the data within the second search space and using the second downlink beam.

In some aspects, a method of wireless communication performed by a UE includes receiving, from a base station, an indication of a change from a first transmission configuration indicator (TCI) state to a second TCI state, wherein the first TCI state is associated with one or more first control channel monitoring occasions, and the second TCI state is associated with one or more second control channel monitoring occasions different than the one or more first control channel monitoring occasions; monitoring for messages from the base station within the one or more second control channel monitoring occasions based at least in part on receiving the indication of the change from the first TCI state to the second TCI state; and receiving, from the base station, a control message based at least in part on monitoring the one or more second control channel monitoring occasions.

In some aspects, a method of wireless communication performed by a base station includes transmitting, to a UE, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; and transmitting, to the UE, a control message within the one or more second control channel monitoring occasions based at least in part on transmitting the indication of the change from the first TCI state to the second TCI state.

In some aspects, an apparatus for wireless communication at a UE includes a memory; and one or more processors, coupled to the memory, configured to receive, from a base station, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; monitor for messages from the base station within the one or more second control channel monitoring occasions based at least in part on the indication of the change from the first TCI state to the second TCI state; and receive, from the base station, a control message based at least in part on the one or more second control channel monitoring occasions being monitored.

In some aspects, an apparatus for wireless communication at a base station includes a memory; and one or more processors, coupled to the memory, configured to transmit, to a UE, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; and transmit, to the UE, a control message within the one or more second control channel monitoring occasions based at least in part on the indication of the change from the first TCI state to the second TCI state.

In some aspects, a non-transitory computer-readable medium storing a set of instructions for wireless communication includes one or more instructions that, when executed by one or more processors of a UE, cause the UE to receive, from a base station, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; monitor for messages from the base station within the one or more second control channel monitoring occasions based at least in part on the indication of the change from the first TCI state to the second TCI state; and receive, from the base station, a control message based at least in part on the one or more second control channel monitoring occasions being monitored.

In some aspects, a non-transitory computer-readable medium storing a set of instructions for wireless communication includes one or more instructions that, when executed by one or more processors of a base station, cause the base station to transmit, to a UE, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; and transmit, to the UE, a control message within the one or more second control channel monitoring occasions based at least in part on the indication of the change from the first TCI state to the second TCI state.

In some aspects, an apparatus for wireless communication includes means for receiving, from a base station, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; means for monitoring for messages from the base station within the one or more second control channel monitoring occasions based at least in part on receiving the indication of the change from the first TCI state to the second TCI state; and means for receiving, from the base station, a control message based at least in part on monitoring the one or more second control channel monitoring occasions.

In some aspects, an apparatus for wireless communication includes means for transmitting, to a UE, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; and means for transmitting, to the UE, a control message within the one or more second control channel monitoring occasions based at least in part on transmitting the indication of the change from the first TCI state to the second TCI state.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of beamforming architecture, in accordance with the present disclosure.

FIG. 4 is a diagram illustrating an example of initial transmission and re-transmission in multicast, in accordance with the present disclosure.

FIG. 5 is a diagram illustrating an example of beam-based monitoring occasions, in accordance with the present disclosure.

FIG. 6 is a diagram illustrating an example associated with beam-based search spaces for initial transmissions and re-transmissions, in accordance with the present disclosure.

FIG. 7 is a diagram illustrating an example associated with shifting from one beam-based re-transmission to another beam-based re-transmission, in accordance with the present disclosure.

FIG. 8 is a diagram illustrating an example associated with soft-combining beam-based transmissions, in accordance with the present disclosure.

FIG. 9 is a diagram illustrating an example associated with configuring beam-based transmissions and re-transmissions, in accordance with the present disclosure.

FIGS. 10A and 10B are diagrams illustrating an example of beam-based multicasting, in accordance with the present disclosure.

FIG. 11 is a diagram illustrating an example of beam-based monitoring occasions, in accordance with the present disclosure.

FIG. 12 is a diagram illustrating an example of beam switching, in accordance with the present disclosure.

FIG. 13 is a diagram illustrating an example associated with switching monitoring occasions based at least in part on beam switching, in accordance with the present disclosure.

FIG. 14 is a diagram illustrating an example associated with control channel overbooking, in accordance with the present disclosure.

FIG. 15 is a diagram illustrating an example associated with beam and search space correspondence for downlink transmissions, in accordance with the present disclosure.

FIGS. 16 and 17 are diagrams illustrating example processes associated with beam-based initial transmissions and re-transmissions, in accordance with the present disclosure.

FIGS. 18 and 19 are diagrams illustrating example processes associated with beam and search space correspondence for downlink transmissions, in accordance with the present disclosure.

FIGS. 20 and 21 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

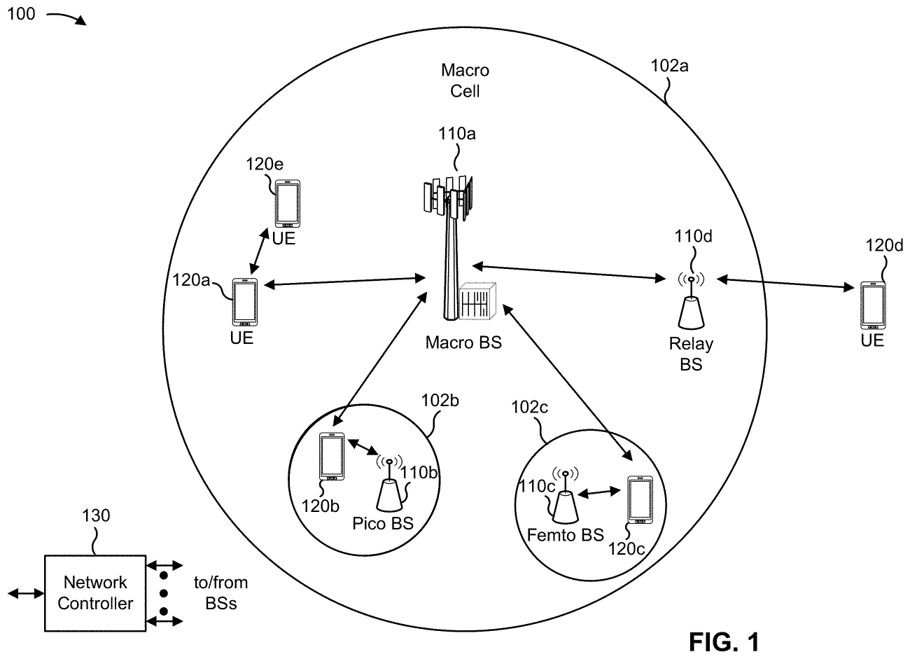

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” or “mmW” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

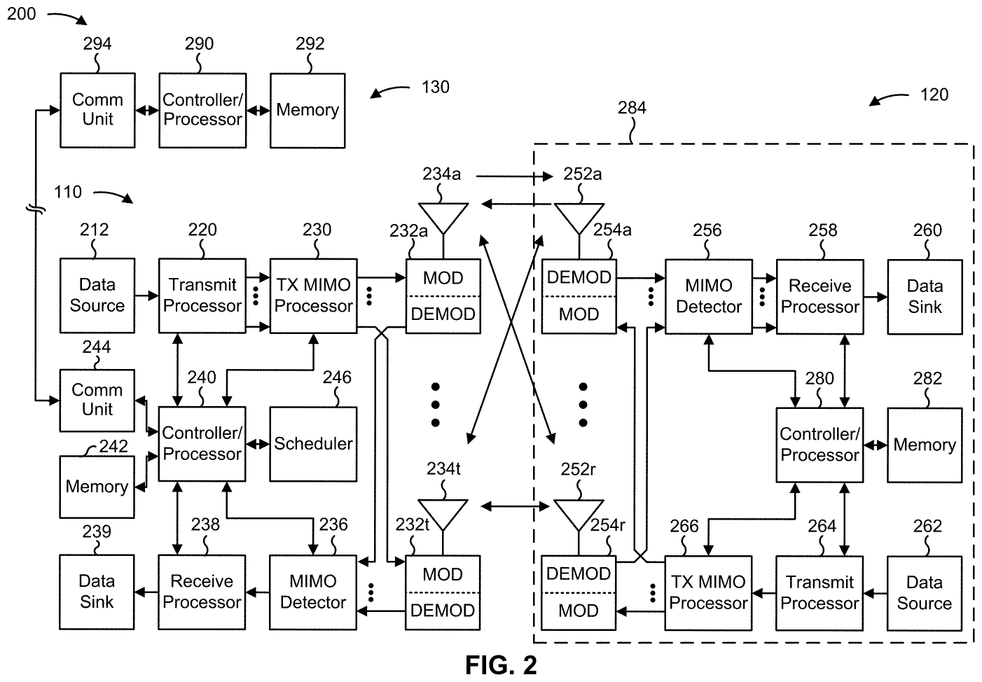

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

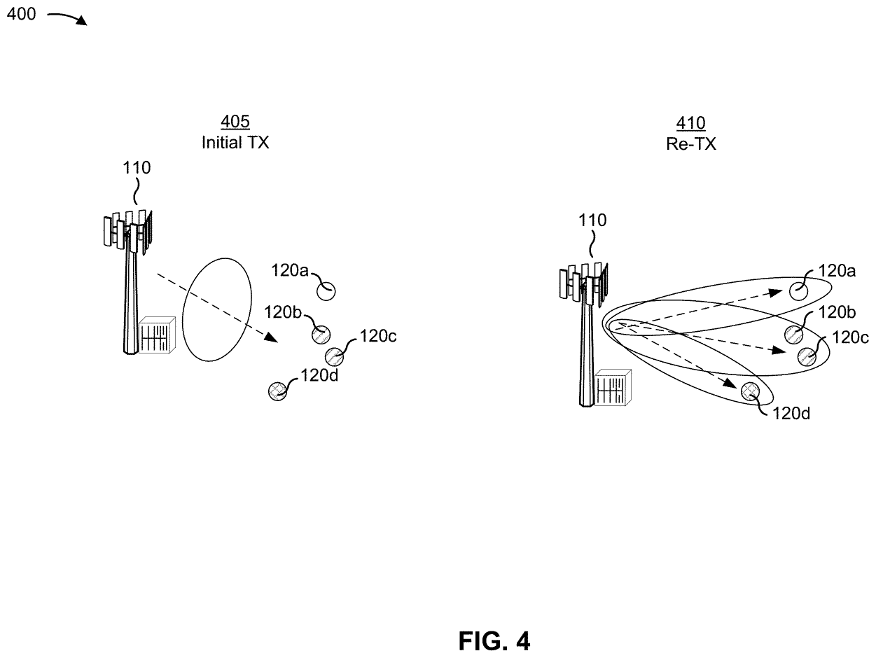

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11 and/or 13-21).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11 and/or 13-21).

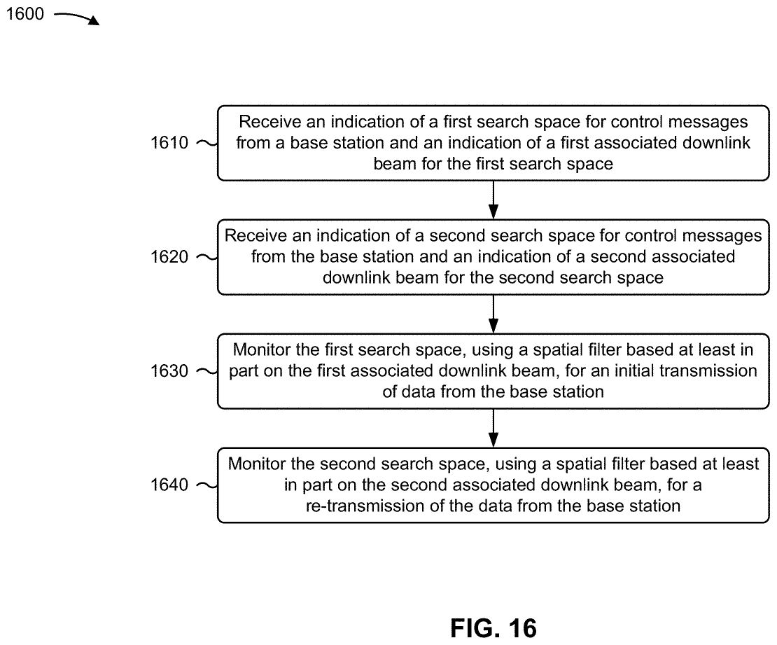

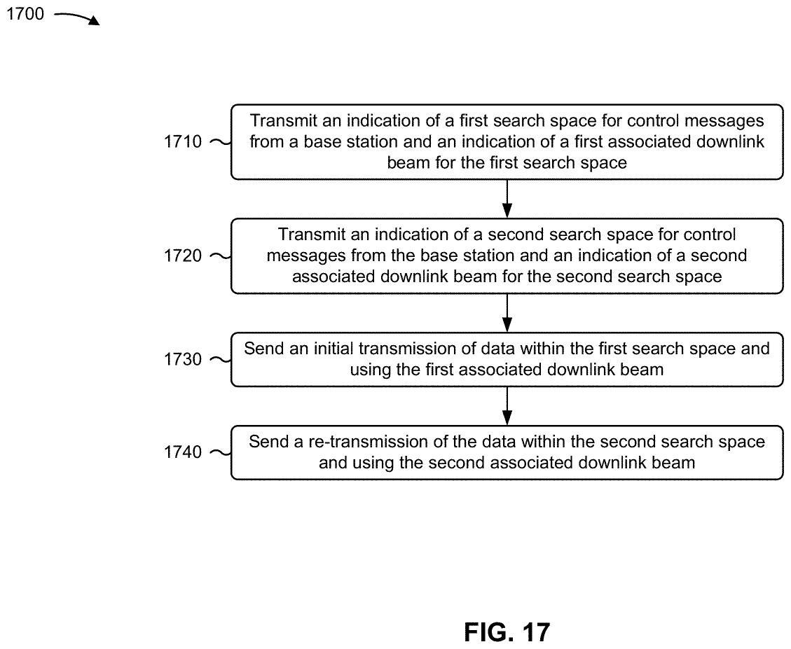

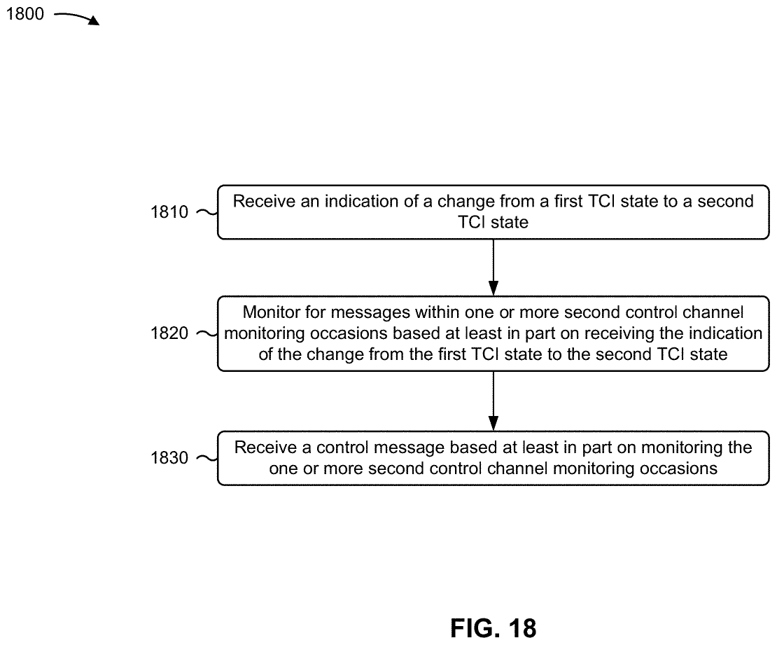

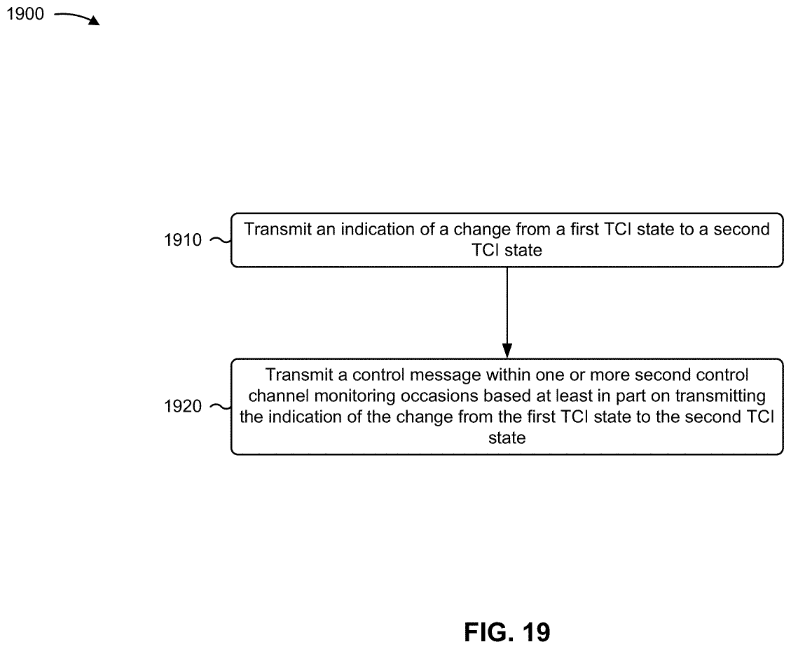

The controller/processor 240 of the base station 110, the controller/processor 280 of the UE 120, and/or any other component(s) of FIG. 2 may perform one or more techniques associated with beam-based initial transmission and re-transmissions and/or associated with beam and search space correspondence for downlink transmissions, as described in more detail elsewhere herein. For example, the controller/processor 240 of the base station 110, the controller/processor 280 of the UE 120, and/or any other component(s) of FIG. 2 may perform or direct operations of, for example, process 1600 of FIG. 16, process 1700 of FIG. 17, process 1800 of FIG. 18, process 1900 of FIG. 19, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1600 of FIG. 16, process 1700 of FIG. 17, process 1800 of FIG. 18, process 1900 of FIG. 19, and/or other processes as described herein. In some examples, executing instructions may include running the instructions, converting the instructions, compiling the instructions, and/or interpreting the instructions, among other examples.

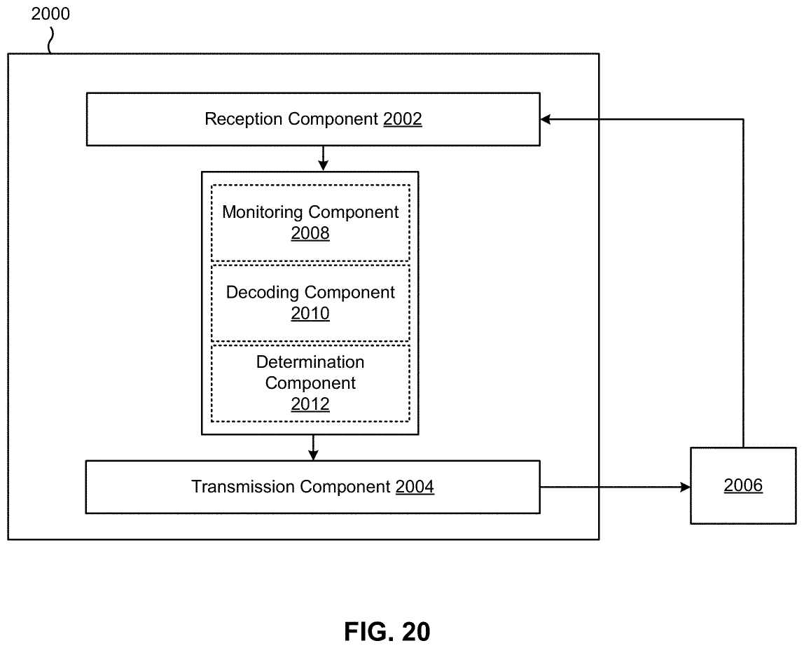

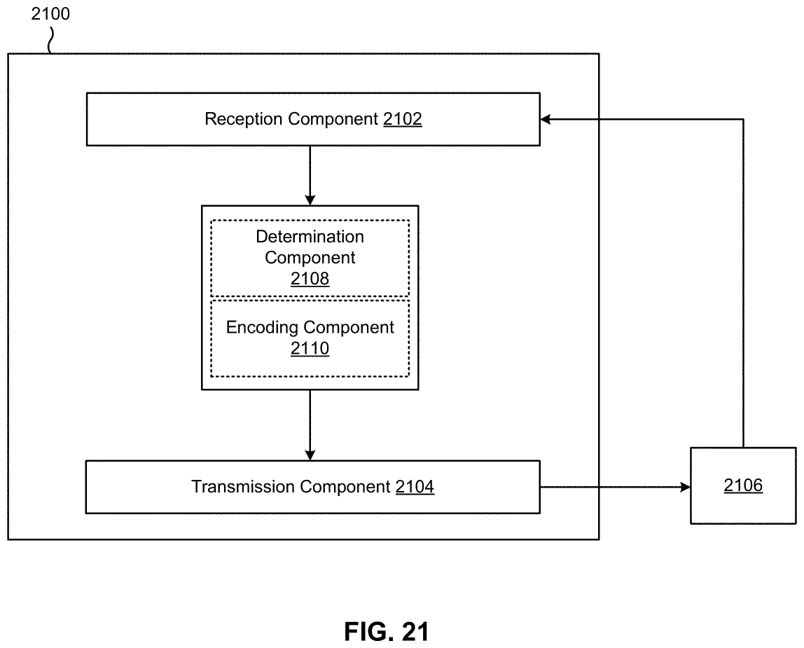

In some aspects, a UE (e.g., the UE 120 and/or apparatus 2000 of FIG. 20) may include means for receiving, from a base station (e.g., the base station 110 and/or apparatus 2100 of FIG. 21), an indication of a first search space for control messages from the base station and an indication of a first downlink beam for the first search space; means for receiving, from the base station, an indication of a second search space for control messages from the base station and an indication of a second downlink beam for the second search space; means for monitoring the first search space, using a spatial filter based at least in part on the first downlink beam, for an initial transmission of data from the base station; and/or means for monitoring the second search space, using a spatial filter based at least in part on the second downlink beam, for re-transmission of the data from the base station. The means for the UE to perform operations described herein may include, for example, one or more of antenna 252, modem 254, MIMO detector 256, receive processor 258, transmit processor 264, TX MIMO processor 266, controller/processor 280, or memory 282.

Additionally, or alternatively, the UE may include means for receiving, from the base station, an indication of a change from a first transmission configuration indicator (TCI) state to a second TCI state, wherein the first TCI state is associated with one or more first control channel monitoring occasions, and the second TCI state is associated with one or more second control channel monitoring occasions different than the one or more first control channel monitoring occasions; means for monitoring for messages from the base station within the one or more second control channel monitoring occasions based at least in part on the indication of the change from the first TCI state to the second TCI state; and/or means for receiving, from the base station, a control message based at least in part on the one or more second control channel monitoring occasions being monitored. The means for the UE to perform operations described herein may include, for example, one or more of antenna 252, modem 254, MIMO detector 256, receive processor 258, transmit processor 264, TX MIMO processor 266, controller/processor 280, or memory 282.

In some aspects, a base station (e.g., the base station 110 and/or apparatus 2100 of FIG. 21) may include means for transmitting, to a UE (e.g., the UE 120 and/or apparatus 2000 of FIG. 20), an indication of a first search space for control messages from the base station and an indication of a first downlink beam for the first search space; means for transmitting, to the UE, an indication of a second search space for control messages from the base station and an indication of a second downlink beam for the second search space; means for sending an initial transmission of data within the first search space and using the first downlink beam; and/or means for sending a re-transmission of the data within the second search space and using the second downlink beam. The means for the base station to perform operations described herein may include, for example, one or more of transmit processor 220, TX MIMO processor 230, modem 232, antenna 234, MIMO detector 236, receive processor 238, controller/processor 240, memory 242, or scheduler 246.

Additionally, or alternatively, the base station may include means for transmitting, to the UE, an indication of a change from a first TCI state to a second TCI state, wherein the first TCI state is associated with one or more first control channel monitoring occasions, and the second TCI state is associated with one or more second control channel monitoring occasions different than the one or more first control channel monitoring occasions; and/or means for transmitting, to the UE, a control message within the one or more second control channel monitoring occasions based at least in part on the indication of the change from the first TCI state to the second TCI state. The means for the base station to perform operations described herein may include, for example, one or more of transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

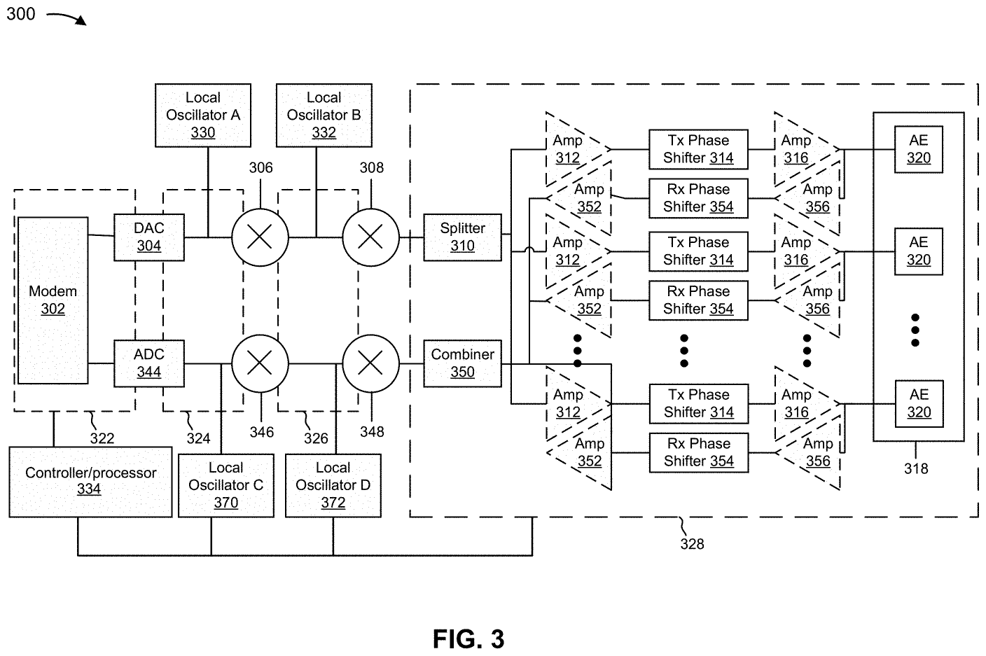

FIG. 3 is a diagram illustrating an example beamforming architecture 300 that supports beamforming for mmW communications, in accordance with the present disclosure. In some aspects, architecture 300 may implement aspects of wireless network 100. In some aspects, architecture 300 may be implemented in a transmitting device (e.g., a first wireless communication device, UE, or base station) and/or a receiving device (e.g., a second wireless communication device, UE, or base station), as described herein.

Broadly, FIG. 3 is a diagram illustrating example hardware components of a wireless communication device in accordance with certain aspects of the disclosure. The illustrated components may include those that may be used for antenna element selection and/or for beamforming for transmission of wireless signals. There are numerous architectures for antenna element selection and implementing phase shifting, only one example of which is illustrated here. The architecture 300 includes a modem (modulator/demodulator) 302, a digital to analog converter (DAC) 304, a first mixer 306, a second mixer 308, and a splitter 310. The architecture 300 also includes multiple first amplifiers 312, multiple phase shifters 314, multiple second amplifiers 316, and an antenna array 318 that includes multiple antenna elements 320. In some examples, the modem 302 may be one or more of the modems 232 or modems 254 described in connection with FIG. 2.

Transmission lines or other waveguides, wires, and/or traces are shown connecting the various components to illustrate how signals to be transmitted may travel between components. Reference numbers 322, 324, 326, and 328 indicate regions in the architecture 300 in which different types of signals travel or are processed. Specifically, reference number 322 indicates a region in which digital baseband signals travel or are processed, reference number 324 indicates a region in which analog baseband signals travel or are processed, reference number 326 indicates a region in which analog intermediate frequency (IF) signals travel or are processed, and reference number 328 indicates a region in which analog radio frequency (RF) signals travel or are processed. The architecture also includes a local oscillator A 330, a local oscillator B 332, and a controller/processor 334. In some aspects, controller/processor 334 corresponds to controller/processor 240 of the base station described above in connection with FIG. 2 and/or controller/processor 280 of the UE described above in connection with FIG. 2.

Each of the antenna elements 320 may include one or more sub-elements for radiating or receiving RF signals. For example, a single antenna element 320 may include a first sub-element cross-polarized with a second sub-element that can be used to independently transmit cross-polarized signals. The antenna elements 320 may include patch antennas, dipole antennas, or other types of antennas arranged in a linear pattern, a two dimensional pattern, or another pattern. A spacing between antenna elements 320 may be such that signals with a desired wavelength transmitted separately by the antenna elements 320 may interact or interfere (e.g., to form a desired beam). For example, given an expected range of wavelengths or frequencies, the spacing may provide a quarter wavelength, half wavelength, or other fraction of a wavelength of spacing between neighboring antenna elements 320 to allow for interaction or interference of signals transmitted by the separate antenna elements 320 within that expected range.

The modem 302 processes and generates digital baseband signals and may also control operation of the DAC 304, first and second mixers 306 and 308, splitter 310, first amplifiers 312, phase shifters 314, and/or the second amplifiers 316 to transmit signals via one or more or all of the antenna elements 320. The modem 302 may process signals and control operation in accordance with a communication standard such as a wireless standard discussed herein. The DAC 304 may convert digital baseband signals received from the modem 302 (and that are to be transmitted) into analog baseband signals. The first mixer 306 upconverts analog baseband signals to analog IF signals within an IF using a local oscillator A 330. For example, the first mixer 306 may mix the signals with an oscillating signal generated by the local oscillator A 330 to “move” the baseband analog signals to the IF. In some cases, some processing or filtering (not shown) may take place at the IF. The second mixer 308 upconverts the analog IF signals to analog RF signals using the local oscillator B 332. Similar to the first mixer, the second mixer 308 may mix the signals with an oscillating signal generated by the local oscillator B 332 to “move” the IF analog signals to the RF or the frequency at which signals will be transmitted or received. The modem 302 and/or the controller/processor 334 may adjust the frequency of local oscillator A 330 and/or the local oscillator B 332 so that a desired IF and/or RF frequency is produced and used to facilitate processing and transmission of a signal within a desired bandwidth.

In the illustrated architecture 300, signals upconverted by the second mixer 308 are split or duplicated into multiple signals by the splitter 310. The splitter 310 in architecture 300 splits the RF signal into multiple identical or nearly identical RF signals. In other examples, the split may take place with any type of signal, including with baseband digital, baseband analog, or IF analog signals. Each of these signals may correspond to an antenna element 320, and the signal travels through and is processed by amplifiers 312 and 316, phase shifters 314, and/or other elements corresponding to the respective antenna element 320 to be provided to and transmitted by the corresponding antenna element 320 of the antenna array 318. In one example, the splitter 310 may be an active splitter that is connected to a power supply and provides some gain so that RF signals exiting the splitter 310 are at a power level equal to or greater than the signal entering the splitter 310. In another example, the splitter 310 is a passive splitter that is not connected to power supply and the RF signals exiting the splitter 310 may be at a power level lower than the RF signal entering the splitter 310.

After being split by the splitter 310, the resulting RF signals may enter an amplifier, such as a first amplifier 312, or a phase shifter 314 corresponding to an antenna element 320. The first and second amplifiers 312 and 316 are illustrated with dashed lines because one or both of them might not be necessary in some aspects. In some aspects, both the first amplifier 312 and second amplifier 316 are present. In some aspects, neither the first amplifier 312 nor the second amplifier 316 is present. In some aspects, one of the two amplifiers 312 and 316 is present but not the other. By way of example, if the splitter 310 is an active splitter, the first amplifier 312 may not be used. By way of further example, if the phase shifter 314 is an active phase shifter that can provide a gain, the second amplifier 316 might not be used.

The amplifiers 312 and 316 may provide a desired level of positive or negative gain. A positive gain (positive dB) may be used to increase an amplitude of a signal for radiation by a specific antenna element 320. A negative gain (negative dB) may be used to decrease an amplitude and/or suppress radiation of the signal by a specific antenna element. Each of the amplifiers 312 and 316 may be controlled independently (e.g., by the modem 302 or the controller/processor 334) to provide independent control of the gain for each antenna element 320. For example, the modem 302 and/or the controller/processor 334 may have at least one control line connected to each of the splitter 310, first amplifiers 312, phase shifters 314, and/or second amplifiers 316 that may be used to configure a gain to provide a desired amount of gain for each component and thus each antenna element 320.

The phase shifter 314 may provide a configurable phase shift or phase offset to a corresponding RF signal to be transmitted. The phase shifter 314 may be a passive phase shifter not directly connected to a power supply. Passive phase shifters might introduce some insertion loss. The second amplifier 316 may boost the signal to compensate for the insertion loss. The phase shifter 314 may be an active phase shifter connected to a power supply such that the active phase shifter provides some amount of gain or prevents insertion loss. The settings of each of the phase shifters 314 are independent, meaning that each can be independently set to provide a desired amount of phase shift or the same amount of phase shift or some other configuration. The modem 302 and/or the controller/processor 334 may have at least one control line connected to each of the phase shifters 314 and which may be used to configure the phase shifters 314 to provide a desired amount of phase shift or phase offset between antenna elements 320.

In the illustrated architecture 300, RF signals received by the antenna elements 320 are provided to one or more first amplifiers 356 to boost the signal strength. The first amplifiers 356 may be connected to the same antenna arrays 318 (e.g., for time division duplex (TDD) operations). The first amplifiers 356 may be connected to different antenna arrays 318. The boosted RF signal is input into one or more phase shifters 354 to provide a configurable phase shift or phase offset for the corresponding received RF signal to enable reception via one or more Rx beams. The phase shifter 354 may be an active phase shifter or a passive phase shifter. The settings of the phase shifters 354 are independent, meaning that each can be independently set to provide a desired amount of phase shift or the same amount of phase shift or some other configuration. The modem 302 and/or the controller/processor 334 may have at least one control line connected to each of the phase shifters 354 and which may be used to configure the phase shifters 354 to provide a desired amount of phase shift or phase offset between antenna elements 320 to enable reception via one or more Rx beams.

The outputs of the phase shifters 354 may be input to one or more second amplifiers 352 for signal amplification of the phase shifted received RF signals. The second amplifiers 352 may be individually configured to provide a configured amount of gain. The second amplifiers 352 may be individually configured to provide an amount of gain to ensure that the signals input to combiner 350 have the same magnitude. The amplifiers 352 and/or 356 are illustrated in dashed lines because they might not be necessary in some aspects. In some aspects, both the amplifier 352 and the amplifier 356 are present. In another aspect, neither the amplifier 352 nor the amplifier 356 are present. In other aspects, one of the amplifiers 352 and 356 is present but not the other.

In the illustrated architecture 300, signals output by the phase shifters 354 (via the amplifiers 352 when present) are combined in combiner 350. The combiner 350 in architecture 300 combines the RF signal into a signal. The combiner 350 may be a passive combiner (e.g., not connected to a power source), which may result in some insertion loss. The combiner 350 may be an active combiner (e.g., connected to a power source), which may result in some signal gain. When combiner 350 is an active combiner, it may provide a different (e.g., configurable) amount of gain for each input signal so that the input signals have the same magnitude when they are combined. When combiner 350 is an active combiner, the combiner 350 may not need the second amplifier 352 because the active combiner may provide the signal amplification.

The output of the combiner 350 is input into mixers 348 and 346. Mixers 348 and 346 generally down convert the received RF signal using inputs from local oscillators 372 and 370, respectively, to create intermediate or baseband signals that carry the encoded and modulated information. The output of the mixers 348 and 346 are input into an analog-to-digital converter (ADC) 344 for conversion to analog signals. The analog signals output from ADC 344 is input to modem 302 for baseband processing, such as decoding, de-interleaving, or similar operations.

The architecture 300 is given by way of example only to illustrate an architecture for transmitting and/or receiving signals. In some cases, the architecture 300 and/or each portion of the architecture 300 may be repeated multiple times within an architecture to accommodate or provide an arbitrary number of RF chains, antenna elements, and/or antenna panels. Furthermore, numerous alternate architectures are possible and contemplated. For example, although only a single antenna array 318 is shown, two, three, or more antenna arrays may be included, each with one or more of their own corresponding amplifiers, phase shifters, splitters, mixers, DACs, ADCs, and/or modems. For example, a single UE may include two, four, or more antenna arrays for transmitting or receiving signals at different physical locations on the UE or in different directions.

Furthermore, mixers, splitters, amplifiers, phase shifters and other components may be located in different signal type areas (e.g., represented by different ones of the reference numbers 322, 324, 326, and 328) in different implemented architectures. For example, a split of the signal to be transmitted into multiple signals may take place at the analog RF, analog IF, analog baseband, or digital baseband frequencies in different examples. Similarly, amplification and/or phase shifts may also take place at different frequencies. For example, in some aspects, one or more of the splitter 310, amplifiers 312 and 316, or phase shifters 314 may be located between the DAC 304 and the first mixer 306 or between the first mixer 306 and the second mixer 308. In one example, the functions of one or more of the components may be combined into one component. For example, the phase shifters 314 may perform amplification to include or replace the first and/or or second amplifiers 312 and 316. By way of another example, a phase shift may be implemented by the second mixer 308 to obviate the need for a separate phase shifter 314. This technique is sometimes called local oscillator (LO) phase shifting. In some aspects of this configuration, there may be multiple IF to RF mixers (e.g., for each antenna element chain) within the second mixer 308, and the local oscillator B 332 may supply different local oscillator signals (with different phase offsets) to each IF to RF mixer.

The modem 302 and/or the controller/processor 334 may control one or more of the other components 304 through 372 to select one or more antenna elements 320 and/or to form beams for transmission of one or more signals. For example, the antenna elements 320 may be individually selected or deselected for transmission of a signal (or signals) by controlling an amplitude of one or more corresponding amplifiers, such as the first amplifiers 312 and/or the second amplifiers 316. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element 320, the radiated signals interact, interfere (constructive and destructive interference), and amplify each other to form a resulting beam. The shape (such as the amplitude, width, and/or presence of side lobes) and the direction (such as an angle of the beam relative to a surface of the antenna array 318) can be dynamically controlled by modifying the phase shifts or phase offsets imparted by the phase shifters 314 and amplitudes imparted by the amplifiers 312 and 316 of the multiple signals relative to each other. The controller/processor 334 may be located partially or fully within one or more other components of the architecture 300. For example, the controller/processor 334 may be located within the modem 302 in some aspects.

As indicated above, FIG. 3 is provided as an example. Other examples may differ from what is described with regard to FIG. 3.

FIG. 4 is a diagram illustrating an example 400 of initial transmission and re-transmission in multicast, in accordance with the present disclosure. As shown in connection with reference number 405, a base station (e.g., base station 110) may multicast data to a plurality of UEs (e.g., UE 120a, UE 120b, UE 120c, and/or UE 120d). Although described in connection with four UEs, the description similarly applies to fewer UEs (e.g., three UEs or two UEs) or to additional UEs (e.g., five UEs, six UEs, and so on). The base station 110 may use a beam (e.g., formed as described above in connection with FIG. 3) for the initial transmission. Accordingly, the UE 120a, the UE 120b, the UE 120c, and the UE 120d may each apply a corresponding spatial filter to receive and decode this initial transmission from the base station 110. In some aspects, the base station 110 may use a low modulation order and/or coding rate such that the data transmission is receivable by any of the UE 120a, the UE 120b, the UE 120c, or the UE 120d with a target error rate.

As shown in connection with reference number 410, the base station 110 may perform multiple re-transmissions of the multicast data. As further shown in connection with reference number 410, the base station 110 may use a plurality of beams (e.g., formed as described above in connection with FIG. 3) for these re-transmissions. In some aspects, the base station 110 may transmit on a portion of the plurality of beams. For example, the base station 110 may determine (e.g., based at least in part in feedback from the UE 120a, the UE 120b, the UE 120c, and/or the UE 120d) which of the plurality of UEs did not receive, or were otherwise unable to decode, the initial transmission. Accordingly, the base station 110 may re-transmit only on beams associated with those UEs that did not receive, or were unable to decode, the initial transmission.

In some aspects, as shown in FIG. 4, the beam used for initial transmission may be wider than each beam of the plurality of beams used for re-transmissions. Accordingly, the UE 120a, the UE 120b, the UE 120c, and the UE 120d may each apply a same spatial filter for the initial transmission and each apply a different spatial filter for the re-transmissions.

In some aspects, as further shown in FIG. 4, one or more of the plurality of beams used for re-transmissions may be used for a group of UE (e.g., the UE 120b and the UE 120c in example 400). Additionally, or alternatively, one or more of the plurality of beams used for re-transmissions may be used for specific UE (e.g., the UE 120a and the UE 120d in example 400).

As indicated above, FIG. 4 is provided as an example. Other examples may differ from what is described with respect to FIG. 4.

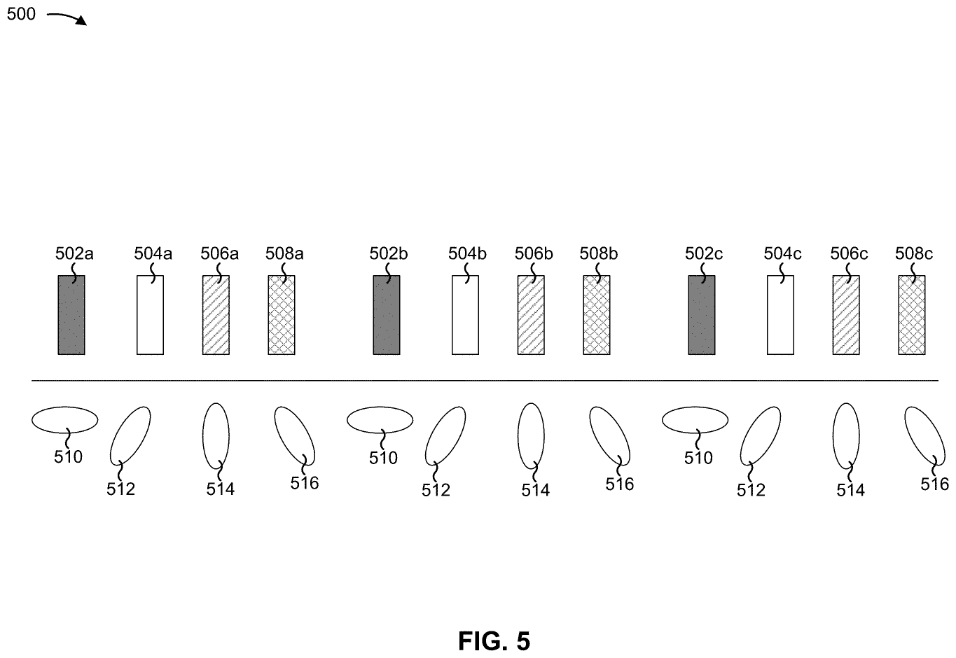

FIG. 5 is a diagram illustrating an example 500 of beam-based monitoring occasions, in accordance with the present disclosure. As shown in FIG. 5, example 500 includes a plurality of search spaces, where each search space includes one or more monitoring occasions. For example, a first search space includes monitoring occasions 502a, 502b, and 502c; a second search space includes monitoring occasions 504a, 504b, and 504c; a third search space includes monitoring occasions 506a, 506b, and 506c; and a fourth search space includes monitoring occasions 508a, 508b, and 508c. Although described in connection with four search spaces, the description similarly applies to fewer search spaces (e.g., three search spaces or two search spaces) or to additional search spaces (e.g., five search spaces, six search spaces, and so on).

The plurality of search spaces may be configured for one or more UEs (e.g., UE 120) by a base station (e.g., base station 110). Accordingly, the base station 110 may use radio resource control (RRC) signaling to configure the UE 120 with the plurality of search spaces.

As further shown in FIG. 5, each search space may correspond to a beam from the base station 110 (e.g., formed as described above in connection with FIG. 3). Example 500 includes a beam 510 that corresponds to the first search space, a beam 512 that corresponds to the second search space, a beam 514 that corresponds to the third search space, and a beam 516 that corresponds to the fourth search space. Although described in connection with four beams, the description similarly applies to fewer beams (e.g., with two or more search spaces corresponding to a same beam) or to additional beams (e.g., with at least one search space corresponding to a plurality of beams). Accordingly, the UE 120 may apply a spatial filter corresponding to the beam when monitoring the search space.

As described herein, a beam may correspond to a transmission configuration, such as a TCI state (e.g., represented by a TCI-State data structure, as defined in 3GPP specifications and/or another standard). For example, a base station and the UE may be configured for beamformed communications, where the base station may transmit in the direction of the UE using a directional BS transmit beam, and the UE may receive the transmission using a directional UE receive beam. Each BS transmit beam may have an associated beam ID, beam direction, or beam symbols, among other examples. Additionally, a downlink beam, such as a BS transmit beam or a UE receive beam, may be associated with a TCI state. A TCI state may indicate a directionality or a characteristic of the downlink beam, such as one or more quasi-co-location (QCL) properties of the downlink beam. For example, a QCL property may be indicated using a qcl-Type indicator within a QCL Info data structure, as defined in 3GPP specifications and/or another standard. A QCL property may include, for example, a Doppler shift, a Doppler spread, an average delay, a delay spread, or spatial receive parameters, among other examples. In some aspects, a TCI state may be further associated with an antenna port, an antenna panel, and/or a TRP. A TCI state may be associated with one downlink reference signal set (for example, a synchronization signal block (SSB) and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). For example, the downlink reference signal may be indicated using a referenceSignal indicator, within a QCL-Info data structure, as defined in 3GPP specifications and/or another standard. In cases where the QCL type indicates spatial receive parameters, the QCL type may correspond to analog receive beamforming parameters of a UE receive beam at the UE.

In some aspects, the base station 110 may transmit control messages (e.g., physical downlink control channel (PDCCH) messages) in the activated search spaces for the UE 120. Accordingly, the base station 110 may transmit the control messages using the beam corresponding to the search space. The control messages may schedule data transmission (e.g., on a physical downlink shared channel (PDSCH)) to the UE 120. In some aspects, the base station 110 may transmit the data using the beam corresponding to the search space used to schedule the data.

Techniques and apparatuses described herein allow a base station (e.g., base station 110) to multicast by configuring a UE (e.g., UE 120) to monitor a first search space in order to schedule an initial transmission and to monitor a second search space in order to schedule a re-transmission. The base station 110 may improve the reliability and/or quality of the multicast transmissions by selecting different beams to use for different UEs when re-transmitting. Additionally, the UE 120 may shift to different search spaces for receiving the re-transmission (e.g., based on changing channel conditions, a mobility of the UE 120, and/or another property) in order to improve reliability and/or quality of the multicast reception. The base station 110 and the UE 120 conserve power and processing resources when reliability and/or quality of communications are increased because chances of additional re-transmissions being needed are reduced.

As indicated above, FIG. 5 is provided as an example. Other examples may differ from what is described with respect to FIG. 5.

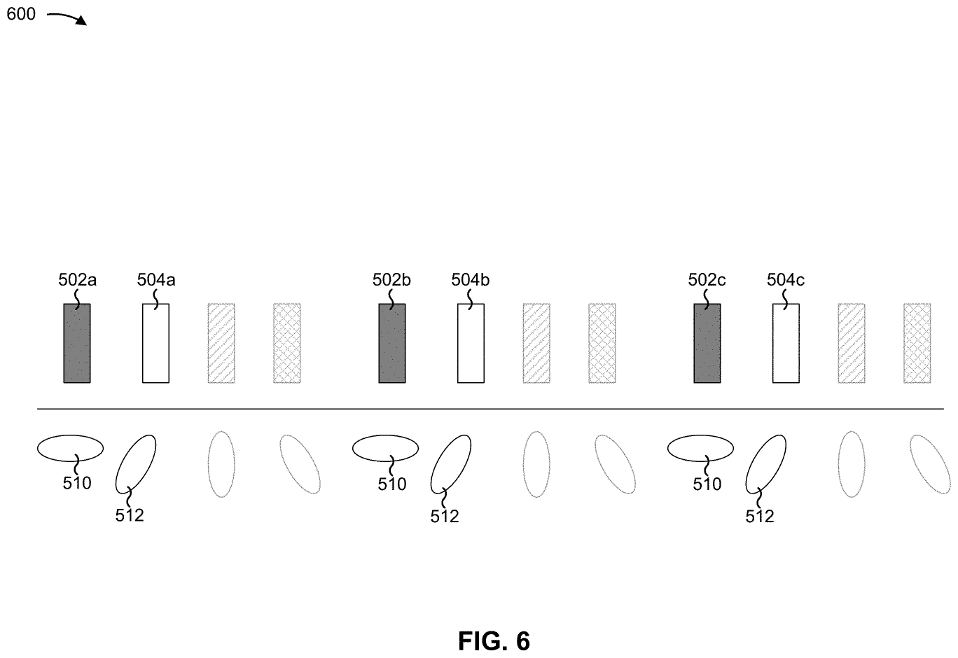

FIG. 6 is a diagram illustrating an example 600 associated with beam-based search spaces for initial transmissions and re-transmissions, in accordance with the present disclosure. As shown in FIG. 6, example 600 includes two search spaces, where each search space includes one or more monitoring occasions. For example, a first search space includes monitoring occasions 502a, 502b, and 502c, and a second search space includes monitoring occasions 504a, 504b, and 504c. Although described in connection with two search spaces, the description similarly applies to additional search spaces (e.g., three search spaces, four search spaces, and so on).

The search spaces may be configured for one or more UEs (e.g., UE 120) by a base station (e.g., base station 110). Accordingly, as described herein, the base station 110 may use RRC signaling to configure the UE 120 with the search spaces.

In some aspects, the UE 120 may receive, from the base station 110, an indication of a first search space for control messages (e.g., PDCCH messages) from the base station 110. Additionally, as described above in connection with FIG. 5, the base station 110 may transmit an indication of a first downlink beam for the first search space.

In some aspects, the indication of the first search space may be a data structure that includes a list of associated TCI states. For example, the indication may be a SearchSpace data structure (e.g., as defined in 3GPP specifications and/or another standard) and may be transmitted by the base station 110, to the UE 120, via RRC signaling. Although the description herein focuses on the SearchSpace data structure, the description similarly applies to other data structures. The SearchSpace data structure may define search spaces (e.g., using monitoringSlotPeriodicityAndOffset, duration, and/or monitoringSymbolsWithinSlot variables, as defined by 3GPP specifications and/or another standard) and may include a list of associated TCI states. For example, the SearchSpace data structure may include a list of TCI-state-IDs (e.g., as defined in 3GPP specifications and/or another standard). Although the description herein focuses on TCI-state-IDs, the description equally applies to other similar identifiers. The TCI-state-IDs may identify corresponding TCI states (e.g., defined in TCI-State data structures and/or other similar data structures). The list may include a TCI state for the first downlink beam associated with the first search space.

As an alternative, the indication of the first search space may be a data structure that includes an identifier, where the identifier is associated with one or more TCI state. For example, the indication may be a SearchSpace data structure and may be transmitted by the base station 110, to the UE 120, via RRC signaling. As described above, the SearchSpace data structure may define search spaces (e.g., using monitoringSlotPeriodicityAndOffset, duration, and/or monitoringSymbolsWithinSlot variables) and may include an identifier. Moreover, the TCI states may be indicated by a tci-StatesPDCCH-ToAddList data structure (e.g., as defined in 3GPP specifications and/or another standard). Although the description herein focuses on tci-StatesPDCCH-ToAddList, the description similarly applies to other data structures. The tci-StatesPDCCH-ToAddList may identify corresponding TCI states (e.g., defined in TCI-State data structures) as well as identifiers for corresponding search spaces. The one or more TCI states may include a TCI state for the first downlink beam.

Based at least in part on receiving the indication of the first search space, the UE 120 may monitor the first search space, using a spatial filter based at least in part on the first downlink beam, for an initial transmission of data from the base station 110. Accordingly, the base station 110 may transmit scheduling information (e.g., PDCCH messages and/or downlink control information (DCI)) within the first search space for the initial transmission. The base station 110 may further transmit data to the UE 120 (e.g., on a PDSCH) based at least in part on the scheduling information.

In some aspects, the UE 120 may further receive, from the base station 110, an indication of a second search space for control messages (e.g., PDCCH messages) from the base station 110. Additionally, as described above in connection with FIG. 5, the base station 110 may transmit an indication of a second downlink beam for the second search space.

As described above, the indication of the second search space may be a data structure that includes a list of associated TCI states. For example, the indication may be a SearchSpace data structure and may be transmitted by the base station 110, to the UE 120, via RRC signaling. As an alternative, and as described above, the indication of the first search space may be a data structure that includes an identifier, where the identifier is associated with one or more TCI states. For example, the TCI states may be indicated by a tci-StatesPDCCH-ToAddList data structure, which may further include identifiers for corresponding search spaces.

Based at least in part on receiving the indication of the second search space, the UE 120 may monitor the second search space, using a spatial filter based at least in part on the second downlink beam, for a re-transmission of the data from the base station 110. Accordingly, the base station 110 may transmit scheduling information (e.g., PDCCH messages and/or DCI) within the second search space for the re-transmission. The base station 110 may further re-transmit the data to the UE 120 (e.g., on a PDSCH) based at least in part on the scheduling information.

In some aspects, the first downlink beam may be associated with a first TCI state, and the second downlink beam may be associated with a second TCI state. For example, the first downlink beam may be indicated using a TCI-State data structure. Similarly, the second downlink beam may be indicated using a TCI-State data structure. Although the description herein focuses on the TCI-State data structure, the description similarly applies to other data structures.

Additionally, or alternatively, the first search space is associated with a first control resource set (CORESET), and the second search space is associated with a second CORESET. For example, the first CORESET may be indicated using a controlResourceSet data structure (e.g., as defined in 3GPP specifications and/or another standard). Similarly, the second CORESET may be indicated using a controlResourceSet data structure. The controlResourceSet data structure may define CORESETs (e.g., using frequencyDomainResources, duration, and/or precoderGranularity variables, as defined by 3GPP specifications and/or another standard) and may include a list of TCI state identifiers (e.g., TCI-state-IDs) in a tci-StatesPDCCH-ToAddList data structure. Although the description herein focuses on the controlResourceSet data structure, the description similarly applies to other data structures.

In some aspects, the first search space may be a common search space. For example, the first search space may be common to a group of UEs including the UE 120 (also referred to as a “common search space” or “CSS”). Accordingly, the UE 120 may monitor the first search space for DCI scrambled with a group identifier (e.g., a group radio network temporary identifier (G-RNTI) and/or another identifier) associated with the group of UEs. As an alternative, the first search space may be a UE-specific search space (USS). Accordingly, the UE 120 may monitor the first search space for DCI scrambled with an identifier (e.g., an RNTI and/or another identifier) specific to the UE 120.

In some aspects, the second search space may be a CSS. Accordingly, the UE 120 may monitor the second search space for DCI scrambled with a group identifier (e.g., a G-RNTI and/or another identifier) associated with the group of UEs. The second search space may be common to the same group of UEs or to a different group of UEs that still includes the UE 120. As an alternative, the second search space may be a USS. Accordingly, the UE 120 may monitor the second search space for DCI scrambled with an identifier (e.g., an RNTI and/or another identifier) specific to the UE 120.

As described above in connection with FIG. 4, in some aspects, the first downlink beam may be wider than the second downlink beam. Accordingly, the first downlink beam may be received by a group of UEs including the UE 120 that is larger than a group of UEs receiving the second downlink beam.

In some aspects, the UE 120 may decode a message that was received, from the base station 110, while monitoring the first search space. Accordingly, the UE 120 may refrain from monitoring the second search space based at least in part on decoding the message.

As an alternative, the UE 120 may detect an error when attempting to decode a message that was received while monitoring the first search space. For example, the UE 120 may encounter a decoding error when attempting to decode DCI, a PDCCH message, and/or another signal transmitted by the base station 110 in the first search space. Accordingly, the UE 120 may monitor the second search space (e.g., as described above) based at least in part on detecting the decoding error.

Additionally with, or alternatively to, the UE 120 monitoring the second search space based at least in part on detecting the decoding error (e.g., as described above), the base station 110 may transmit, and the UE 120 may receive, information activating the second search space. For example, the information activating the second search space may include a medium access control (MAC) layer control element (MAC-CE), DCI, and/or other information. Accordingly, the UE 120 may monitor the second search space based at least in part on receiving the information activating the second search space.

In some aspects, the UE 120 may transmit, and the base station 110 may receive, a signal indicating a decoding error that the UE 120 detected when attempting to decode a message that was received while monitoring the first search space (e.g., as described above). For example, the signal may include a non-acknowledgement (NACK) signal and/or other hybrid automatic repeat request (HARD) feedback. Accordingly, the base station 110 may transmit, and the UE 120 may receive, the information activating the second search space (e.g., as described above) based at least in part on the signal indicating the decoding error.

By using techniques as described in connection with FIG. 6, the base station 110 improves the reliability and/or quality of the multicast transmissions by using different beams for initial transmissions and re-transmissions. Accordingly, the base station 110 increases spectral efficiency and reduce network overhead by reducing a need for repeated re-transmissions using a same beam. Additionally, the base station 110 and the UE 120 conserve power and processing resources by reducing a need for repeated re-transmissions.

As indicated above, FIG. 6 is provided as an example. Other examples may differ from what is described with respect to FIG. 6.

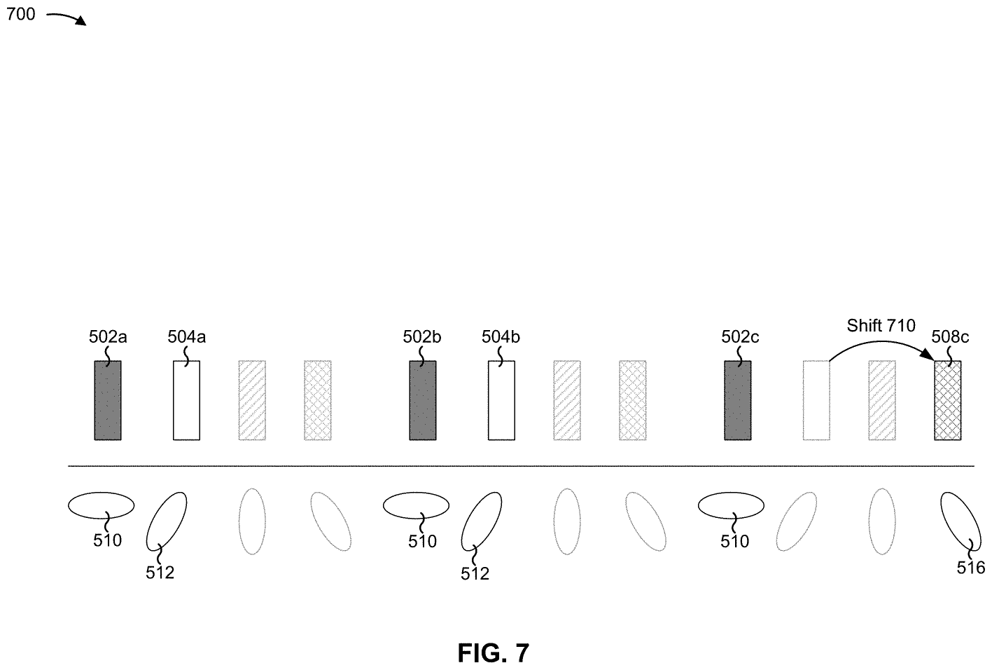

FIG. 7 is a diagram illustrating an example 700 associated with shifting from one beam-based re-transmission to another beam-based re-transmission, in accordance with the present disclosure. As shown in FIG. 7, example 700 includes a plurality of search spaces, where each search space includes one or more monitoring occasions. For example, a first search space includes monitoring occasions 502a, 502b, and 502c; a second search space includes monitoring occasions 504a and 504b; and a third search space includes monitoring occasion 508c. Although described in connection with three search spaces, the description similarly applies to additional search spaces (e.g., four search spaces, five search spaces, and so on).

The search spaces may be configured for one or more UEs (e.g., UE 120) by a base station (e.g., base station 110). Accordingly, as described herein, the base station 110 may use RRC signaling to configure the UE 120 with the search spaces.

In some aspects, as described above in connection with FIG. 6, the UE 120 may receive, from the base station 110, an indication of a first search space for control messages (e.g., PDCCH messages) from the base station 110. Additionally, as described above in connection with FIG. 5, the base station 110 may transmit an indication of a first downlink beam for the first search space.

In some aspects, as described above in connection with FIG. 6, the UE 120 may further receive, from the base station 110, an indication of a second search space for control messages (e.g., PDCCH messages) from the base station 110. Additionally, as described above in connection with FIG. 5, the base station 110 may transmit an indication of a second downlink beam for the second search space.

In some aspects, the UE 120 may further receive, from the base station 110, an indication of a third search space for control messages (e.g., PDCCH messages) from the base station 110. Additionally, as described above in connection with FIG. 5, the base station 110 may transmit an indication of a third downlink beam for the third search space.

As shown in FIG. 7, the UE 120 may monitor the first search space, using a spatial filter based at least in part on the first downlink beam, for an initial transmission of data from the base station 110. Accordingly, the base station 110 may transmit scheduling information (e.g., PDCCH messages and/or DCI) within the first search space for the initial transmission. The base station 110 may further transmit data to the UE 120 (e.g., on a PDSCH) based at least in part on the scheduling information. Additionally, the UE 120 may monitor the second search space, using a spatial filter based at least in part on the second downlink beam, for a re-transmission of the data from the base station 110. Accordingly, the base station 110 may transmit scheduling information (e.g., PDCCH messages and/or DCI) within the second search space for the re-transmission. The base station 110 may further re-transmit the data to the UE 120 (e.g., on a PDSCH) based at least in part on the scheduling information.

In some aspects, as described above in connection with FIG. 6, the UE 120 may monitor the second search space based at least in part on information, from the base station 110, activating the second search space. In some aspects, the UE 120 may transmit, and the base station 110 may receive, information related to a strength of the second downlink beam. For example, the information related to the strength of the second downlink beam may include an RSRP, a CQI, a channel state information (CSI) report, and/or other similar information. Accordingly, the base station 110 may transmit, and the UE 120 may receive, the information activating the second search space based at least in part on the information related to the strength of the second downlink beam. For example, the base station 110 may determine that a signal strength of the second downlink beam satisfies a threshold and/or is a maximum; an interference strength of the second downlink beam satisfies a threshold and/or is a minimum; a quality indicator associated with the second downlink beam satisfies a condition; and/or otherwise determines to use the second downlink beam rather than one or more additional downlink beams (e.g., the third downlink beam).

Additionally, or alternatively, the UE 120 may monitor the second search space based at least in part on determining that the second downlink beam is preferred to one or more additional downlink beams (e.g., the third downlink beam). For example, the UE 120 may determine that the second downlink beam is preferred to the one or more additional downlink beams based at least in part on a signal strength of the second downlink beam (e.g., satisfying a threshold and/or being a maximum), an interference strength of the second downlink beam (e.g., satisfying a threshold and/or being a minimum), and/or a quality indicator associated with the second downlink beam (e.g., satisfying a condition). In some aspects, the UE 120 may determine that the second downlink beam is preferred to the one or more additional downlink beams based at least in part on a combination of factors. For example, the UE 120 may determine that the second downlink beam is preferred to the one or more additional downlink beams based at least in part on a signal strength of the second downlink beam being a maximum and an interference strength of the second downlink beam satisfying a threshold. As another example, the UE 120 may determine that the second downlink beam is preferred to the one or more additional downlink beams based at least in part on a quality indicator associated with the second downlink beam satisfying a condition and an interference strength of the second downlink beam being a minimum.

As further shown in FIG. 7, the UE 120 may perform a shift 710 from monitoring the second search space using a spatial filter based at least in part on the second downlink beam to monitoring the third search space using a spatial filter based at least in part on the third downlink beam. In some aspects, the UE 120 may perform the shift based at least in part on information, received from the base station 110, that activates the third search space. Additionally, or alternatively, the UE 120 may perform the shift based at least on determining that the third downlink beam is preferred to one or more additional downlink beams, such as the second downlink beam (e.g., as described above).

In some aspects, the UE 120 may perform the shift based at least in part on a decoding error. The UE 120 may detect an error when attempting to decode a message that was received while monitoring the second search space and transmit, to the base station 110, a signal indicating the decoding error. Based at least in part on the signal, the base station 110 may transmit, and the UE 120 may receive, information that activates the third search space. In some aspects, the UE 120 may transmit the signal indicating the decoding error on an uplink resource associated with the second search space. As an alternative, the UE 120 may transmit the signal indicating the decoding error on an uplink resource associated with the third search space. For example, the UE 120 may determine that the third downlink beam is preferred to one or more additional downlink beams, such as the second downlink beam (e.g., as described above), and therefore transmit the signal on an uplink resource associated with the third search space. Accordingly, the base station 110 may determine to activate the third search space based at least in part on receiving the signal on the uplink resource associated with the third search space.

By using techniques as described in connection with FIG. 7, the UE 120 improves the reliability and/or quality of the multicast transmissions by moving between beams for re-transmissions. Accordingly, the UE 120 reduces resource overhead by reducing decoding errors for future re-transmissions. Additionally, the UE 120 conserves power and processing resources by reducing decoding errors for future re-transmissions.

As indicated above, FIG. 7 is provided as an example. Other examples may differ from what is described with respect to FIG. 7.

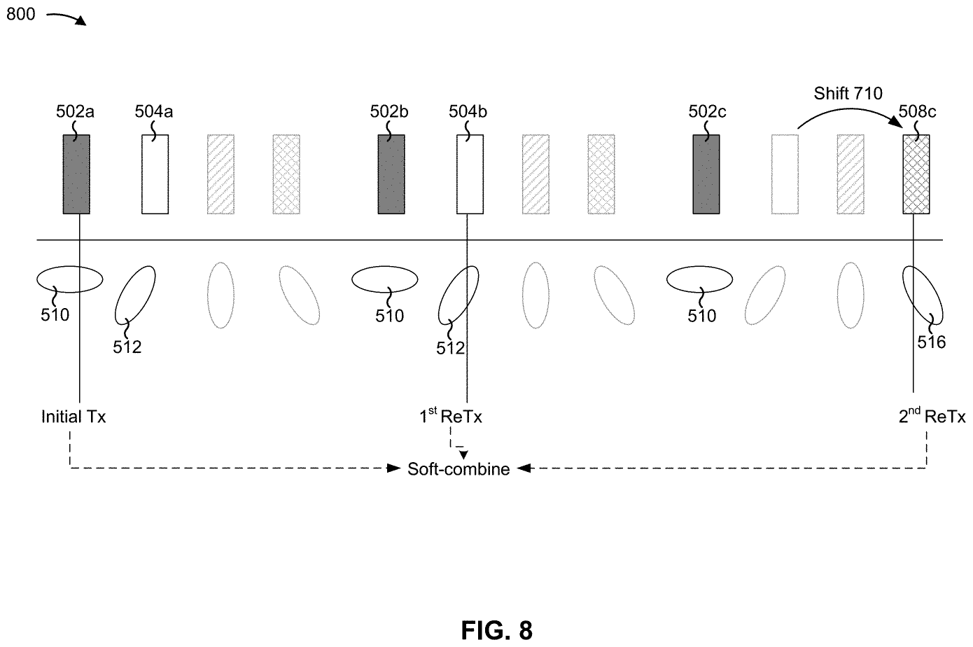

FIG. 8 is a diagram illustrating an example 800 associated with soft-combining beam-based transmissions, in accordance with the present disclosure. As shown in FIG. 8, example 800 includes a plurality of search spaces, where each search space includes one or more monitoring occasions. As shown in FIG. 8, example 800 includes a plurality of search spaces, where each search space includes one or more monitoring occasions. For example, a first search space includes monitoring occasions 502a, 502b, and 502c; a second search space includes monitoring occasions 504a and 504b; and a third search space includes monitoring occasion 508c. Although described in connection with three search spaces, the description similarly applies to additional search spaces (e.g., four search spaces, five search spaces, and so on).

The search spaces may be configured for one or more UE (e.g., UE 120) by a base station (e.g., base station 110). Accordingly, as described herein, the base station 110 may use RRC signaling to configure the UE 120 with the search spaces.

In some aspects, as described above in connection with FIG. 6, the UE 120 may receive, from the base station 110, an indication of a first search space for control messages (e.g., PDCCH messages) from the base station 110. Additionally, as described above in connection with FIG. 5, the base station 110 may transmit an indication of a first downlink beam for the first search space.

In some aspects, as described above in connection with FIG. 6, the UE 120 may further receive, from the base station 110, an indication of a second search space for control messages (e.g., PDCCH messages) from the base station 110. Additionally, as described above in connection with FIG. 5, the base station 110 may transmit an indication of a second downlink beam for the second search space.

In some aspects, the UE 120 may further receive, from the base station 110, an indication of a third search space for control messages (e.g., PDCCH messages) from the base station 110. Additionally, as described above in connection with FIG. 5, the base station 110 may transmit an indication of a third downlink beam for the third search space.

As shown in FIG. 8, the UE 120 may monitor the first search space, using a spatial filter based at least in part on the first downlink beam, for an initial transmission of data from the base station 110. Accordingly, the base station 110 may transmit scheduling information (e.g., PDCCH messages and/or DCI) within the first search space for the initial transmission. The base station 110 may further transmit data to the UE 120 (e.g., on a PDSCH) based at least in part on the scheduling information.

In some aspects, the UE 120 may detect an error when attempting to decode a message that was received while monitoring the first search space. For example, the UE 120 may encounter a decoding error when attempting to decode DCI, a PDCCH message, and/or another signal transmitted by the base station 110 in the first search space. Accordingly, as further shown in FIG. 8, the UE 120 may transmit, and the base station 110 may receive, a signal indicating the decoding error. For example, the signal may include a NACK signal and/or other HARQ feedback. In some aspects, the base station 110 may transmit, and the UE 120 may receive, information activating the second search space based at least in part on the signal indicating the decoding error.

Accordingly, as further shown in FIG. 8, the UE 120 may monitor the second search space, using a spatial filter based at least in part on the second downlink beam, for a re-transmission of the data from the base station 110. In some aspects, the UE 120 may decode a message from the base station 110 by soft-combining a signal scheduled by DCI received in the first search space with an additional signal scheduled by DCI received in the second search space. Soft-combining may include combining data blocks scheduled by the DCI received in the first search space that were successfully decoded with data blocks scheduled by the DCI received in the second search space that were successfully decoded. In some aspects, the UE 120 may recover the data by soft-combining.

In some aspects, the UE 120 may detect an error when attempting to decode a message that was received while monitoring the second search space. For example, the UE 120 may encounter a decoding error even when soft-combining data scheduled by the DCI message received in the first search space with additional data scheduled by the DCI message received in the second search space. Accordingly, the UE 120 may switch to monitoring the third search space (e.g., as described above in connection with FIG. 7) and decode a message from the base station by soft-combining a signal scheduled by DCI received in the first search space and/or a signal scheduled by DCI received in the second search space with an additional signal scheduled by DCI received in the third search space. Soft-combining may include combining data blocks scheduled by the DCI received in the first search space that were successfully decoded and/or data blocks scheduled by the DCI received in the second search space that were successfully decoded with data blocks scheduled by the DCI received in the third search space that were successfully decoded. In some aspects, as shown in FIG. 8, the UE 120 may recover the data by soft-combining.

By using techniques as described in connection with FIG. 8, the UE 120 improves the reliability and/or quality of the multicast transmissions by using soft-combining to reduce decoding errors. Accordingly, the UE 120 reduces resource overhead by improving decoding efficiency and/or quality. Additionally, the UE 120 conserves power and processing resources by reducing decoding errors.

As indicated above, FIG. 8 is provided as an example. Other examples may differ from what is described with respect to FIG. 8.

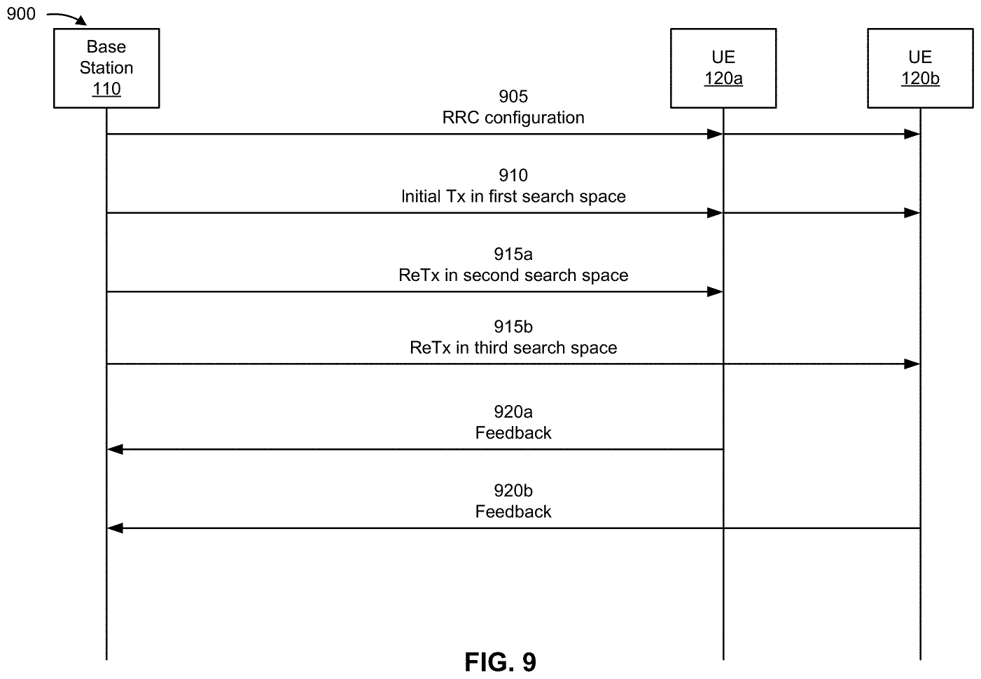

FIG. 9 is a diagram illustrating an example 900 associated with configuring beam-based transmissions and re-transmissions, in accordance with the present disclosure. As shown in FIG. 9, example 900 includes a base station 110 multicasting data to a group of UE including UE 120a and UE 120b. In some aspects, the base station 110, the UE 120a, and the UE 120b may be included in a wireless network, such as wireless network 100.

As described above in connection with FIG. 6, the base station 110 may transmit, and the UE 120a and the UE 120b may receive, an indication of a first search space for control messages (e.g., PDCCH messages) from the base station 110. For example, as shown in connection with reference number 905, the base station 110 may use an RRC configuration to indicate the first search space. Additionally, as described above in connection with FIG. 5, the base station 110 may transmit (e.g., using RRC signaling) an indication of a first downlink beam for the first search space.

In some aspects, the base station 110 may further transmit, and the UE 120a may further receive, an indication of a second search space for control messages (e.g., PDCCH messages) from the base station 110. For example, the base station 110 may use an RRC configuration to indicate the second search space. Additionally, as described above in connection with FIG. 5, the base station 110 may transmit (e.g., using RRC signaling) an indication of a second downlink beam for the second search space.

In some aspects, the base station 110 may further transmit, and the UE 120b may further receive, an indication of a third search space for control messages (e.g., PDCCH messages) from the base station 110. For example, the base station 110 may use an RRC configuration to indicate the third search space. Additionally, as described above in connection with FIG. 5, the base station 110 may transmit (e.g., using RRC signaling) an indication of a third downlink beam for the third search space.

As shown in connection with reference number 910, and based at least in part on receiving the indication of the first search space, the UE 120a and the UE 120b may monitor the first search space, using a spatial filter based at least in part on the first downlink beam, for an initial transmission of data from the base station 110. Accordingly, the base station 110 may transmit scheduling information (e.g., PDCCH messages and/or DCI) within the first search space for the initial transmission. The base station 110 may further transmit data to the UE 120 (e.g., on a PDSCH) based at least in part on the scheduling information.

As shown in connection with reference number 915a, and based at least in part on receiving the indication of the second search space, the UE 120a may monitor the second search space, using a spatial filter based at least in part on the second downlink beam, for a re-transmission of the data from the base station 110. For example, the UE 120a may monitor the second search space when failing to decode the data from the initial transmission (e.g., as described above in connection with reference number 910). Accordingly, the base station 110 may transmit scheduling information (e.g., PDCCH messages and/or DCI) within the second search space for the re-transmission. The base station 110 may further re-transmit the data to the UE 120a (e.g., on a PDSCH) based at least in part on the scheduling information.

As shown in connection with reference number 915b, and based at least in part on receiving the indication of the third search space, the UE 120b may monitor the third search space, using a spatial filter based at least in part on the third downlink beam, for a re-transmission of the data from the base station 110. For example, the UE 120b may monitor the second search space when failing to decode the data from the initial transmission (e.g., as described above in connection with reference number 910). Accordingly, the base station 110 may transmit scheduling information (e.g., PDCCH messages and/or DCI) within third search space for the re-transmission. The base station 110 may further re-transmit the data to the UE 120b (e.g., on a PDSCH) based at least in part on the scheduling information.

As shown in connection with reference number 920a, the UE 120a may transmit, and the base station 110 may receive, feedback associated with the second search space and/or the second downlink beam. For example, the UE 120 may provide HARQ feedback and/or information related to a quality of the third downlink beam (e.g., RSRP, one or more CQIs, a CSI report, and/or other similar information). In some aspects, based at least in part on the feedback, the base station 110 and/or the UE 120a may switch from the second search space to another search space (e.g., a fourth search space related to a fourth downlink beam) to monitor for re-transmissions.

As shown in connection with reference number 920b, the UE 120a may transmit, and the base station 110 may receive, feedback associated with the third search space and/or the third downlink beam. For example, the UE 120 may provide HARQ feedback and/or information related to a quality of the third downlink beam (e.g., RSRP, one or more CQIs, a CSI report, and/or other similar information). In some aspects, based at least in part on the feedback, the base station 110 and/or the UE 120b may switch from the second search space to another search space (e.g., the fourth search space related to the fourth downlink beam) to monitor for re-transmissions.

By using techniques as described in connection with FIG. 9, the base station 110 improves the reliability and/or quality of the multicast transmissions by selecting different beams for different UE when re-transmitting. Additionally, the UE (e.g., the UE 120a and/or the UE 120b) may provide feedback to the base station 110 and trigger switching to different search spaces for future re-transmissions (e.g., based on changing channel conditions, mobility, and/or the like) in order to improve reliability and/or quality of the multicast reception. Additionally, the base station 110, the UE 120a, and the UE 120b conserve power and processing resources by reducing a need for repeated re-transmissions.

As indicated above, FIG. 9 is provided as an example. Other examples may differ from what is described with respect to FIG. 9.

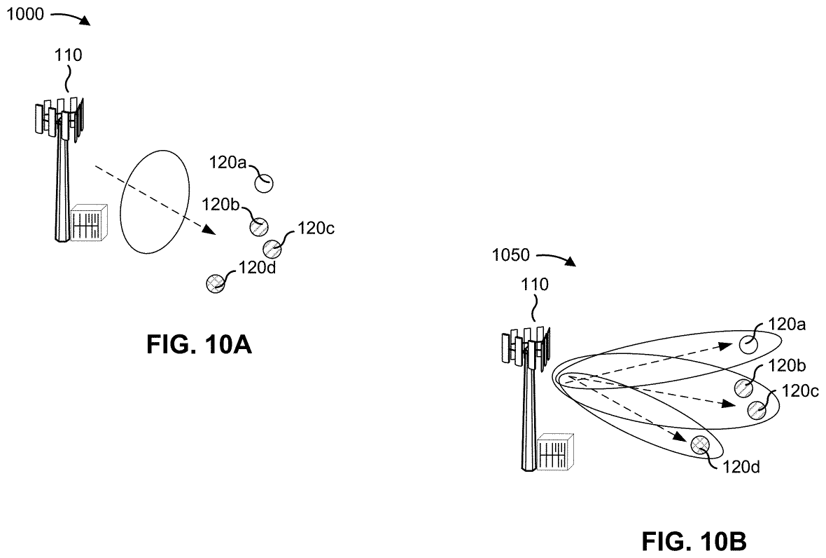

FIGS. 10A and 10B are diagrams illustrating examples 1000 and 1050, respectively, of initial transmission and re-transmission in multicast, in accordance with the present disclosure. As shown in FIG. 10A, a base station (e.g., base station 110) may multicast data to a plurality of UEs (e.g., UE 120a, UE 120b, UE 120c, and/or UE 120d). Although described in connection with four UEs, the description similarly applies to fewer UEs (e.g., three UEs or two UEs) or to additional UEs (e.g., five UEs, six UEs, and so on). The base station 110 may use a beam (e.g., formed as described above in connection with FIG. 3) for this transmission. Accordingly, the UE 120a, the UE 120b, the UE 120c, and the UE 120d may apply a corresponding spatial filter to receive and decode this transmission from the base station 110.

As shown in FIG. 10B, a base station (e.g., base station 110) may perform multiple transmissions of multicast data. As further shown in FIG. 10B, the base station 110 may use a plurality of beams (e.g., formed as described above in connection with FIG. 3) for these transmissions. Accordingly, the UE 120a, the UE 120b, the UE 120c, and the UE 120d may each apply corresponding spatial filters to receive and decode these transmissions from the base station 110. In some aspects, the beam used for the transmission shown in FIG. 10A may be wider than each beam of the plurality of beams used for the transmissions shown in FIG. 10B.

In some aspects, as further shown in FIG. 10B, one or more of the plurality of beams may be used for a group of UEs (e.g., the UE 120b and the UE 120c in example 1050). Additionally, or alternatively, one or more of the plurality of beams may be used for a specific UE (e.g., the UE 120a and the UE 120d in example 1050).

In some aspects, the transmission shown in FIG. 10A may be an initial transmission and the transmissions shown in FIG. 10B may be re-transmissions. Accordingly, the UE 120a, the UE 120b, the UE 120c, and the UE 120d may each apply a same spatial filter for the initial transmission and each apply a different spatial filter for the re-transmissions.

As indicated above, FIGS. 10A and 10B are provided as examples. Other examples may differ from what is described with respect to FIGS. 10A and 10B.

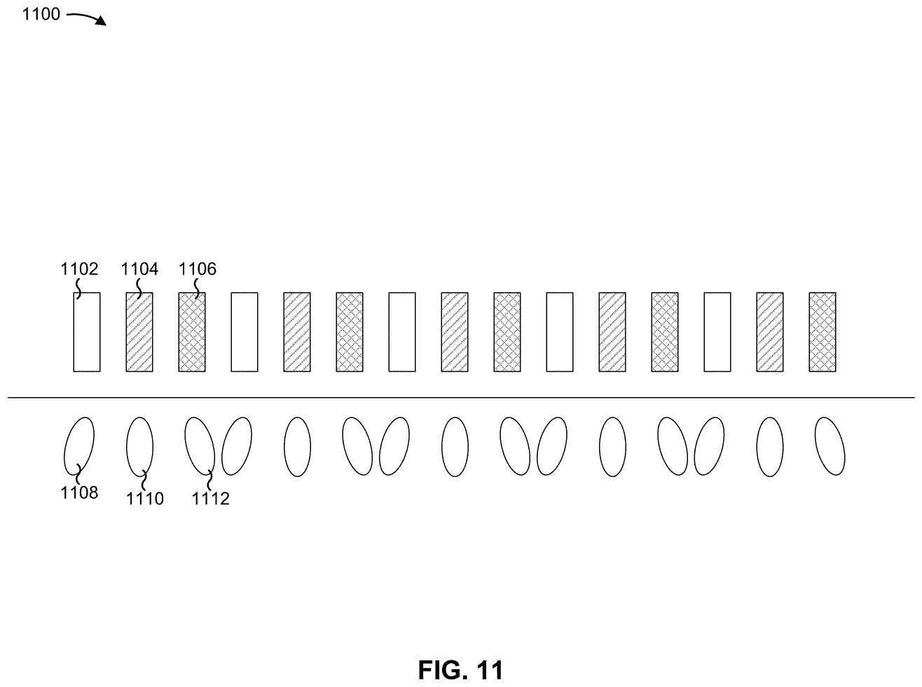

FIG. 11 is a diagram illustrating an example 1100 of beam-based monitoring occasions, in accordance with the present disclosure. As shown in FIG. 11, example 1100 includes a plurality of monitoring occasions (e.g., occasion 1102, occasion 1104, and occasion 1106). Although described in connection with three monitoring occasions, the description similarly applies to fewer monitoring occasions (e.g., two monitoring occasions) or to additional monitoring occasions (e.g., four monitoring occasions, five monitoring occasions, and so on). A UE (e.g., UE 120) may monitor one or more of the monitoring occasions for a control channel (e.g., a PDCCH) with a base station (e.g., base station 110).

In some aspects, the monitoring occasions may be grouped. For example, monitoring occasion 1102 may be associated with a first group of monitoring occasions that repeats periodically. Similarly, monitoring occasion 1104 may be associated with a second group of monitoring occasions that repeats periodically, and monitoring occasion 1106 may be associated with a third group of monitoring occasions that repeats periodically.

As further shown in FIG. 11, the first group of monitoring occasions (including monitoring occasion 1102) may be associated with a first beam 1108 (e.g., formed as described above in connection with FIG. 3). Accordingly, the first group of monitoring occasions may be associated with a TCI state for the first beam. Similarly, the second group of monitoring occasions (including monitoring occasion 1104) may be associated with a second beam 1110 (e.g., formed as described above in connection with FIG. 3). Accordingly, the second group of monitoring occasions may be associated with a TCI state for the second beam. Similarly, the third group of monitoring occasions (including monitoring occasion 1106) may be associated with a third beam 1112 (e.g., formed as described above in connection with FIG. 3). Accordingly, the third group of monitoring occasions may be associated with a TCI state for the third beam.

Although described in connection with three beams, the description similarly applies to fewer beams (e.g., with two or more search spaces corresponding to a same beam) or to additional beams (e.g., with at least one search space corresponding to a plurality of beams).

As indicated above, FIG. 11 is provided as an example. Other examples may differ from what is described with respect to FIG. 11.

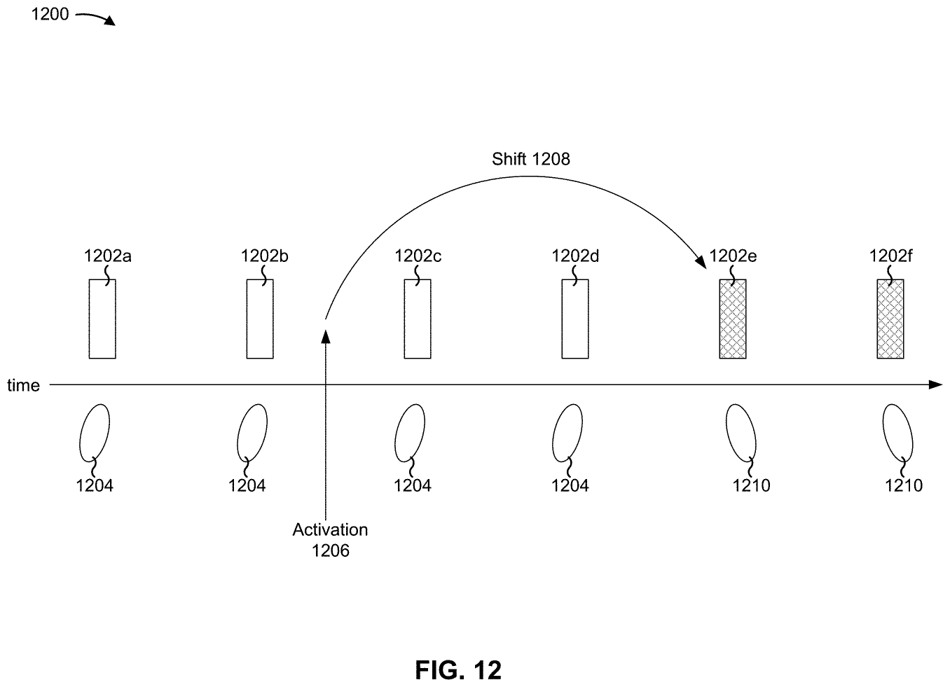

FIG. 12 is a diagram illustrating an example 1200 of beam switching, in accordance with the present disclosure. As shown in FIG. 12, example 1200 includes a set of monitoring occasions (e.g., occasion 1202a, occasion 1202b, occasion 1202c, occasion 1202d, occasion 1202e, and occasion 1202f). A UE may monitor one or more of the monitoring occasions for a control channel (e.g., a PDCCH) with a base station.

As further shown in FIG. 12, the set of monitoring occasions may be associated with a first beam 1204. Accordingly, the set of monitoring occasions may be associated with a TCI state for the first beam 1204.

As further shown in connection with reference number 1206, the UE may receive (e.g., from the base station) an activation of a new TCI state associated with a second beam 1210 (e.g., a MAC-CE, DCI, and/or an RRC signal). Accordingly, as shown in connection with reference number 1208, the UE may shift to a new spatial filter based on the second beam 1210 in lieu of a spatial filter based on the first beam 1204.

However, as shown in FIG. 12, the UE will continue monitoring the same set of monitoring occasions. Accordingly, the base station will incur network overhead and consume processing resources in changing beams for the set of monitoring occasions. Moreover, the base station will increase latency and consume processing resources by verifying that the second beam does not interfere with any other beams used on the set of monitoring occasions.

Techniques and apparatuses described herein allow a base station (e.g., base station 110) to configure a UE (e.g., UE 120) for a new TCI state and, using the same configuration, a new group of monitoring occasions. The base station 110 may avoid re-determining whether the new TCI state interferes with other TCI states when configuring the UE 120 for the new group of monitoring occasions. Instead, the base station 110 may initially configure different beams for association with different groups of monitoring occasions and avoid reconfiguration of those associations. Accordingly, the base station 110 conserves processing resources and reduces latency. Additionally, the UE 120 experiences improved reliability and/or quality of communications with the base station 110 due to more optimized associations between different beams and different groups of monitoring occasions.

As indicated above, FIG. 12 is provided as an example. Other examples may differ from what is described with respect to FIG. 12.

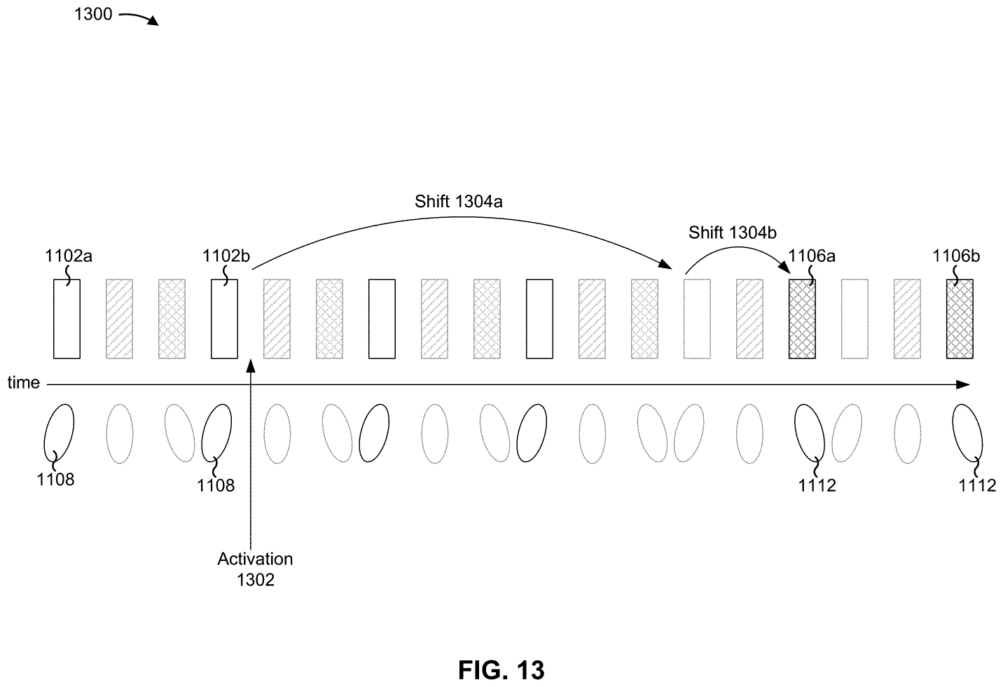

FIG. 13 is a diagram illustrating an example 1300 associated with switching monitoring occasions based at least in part on beam switching, in accordance with the present disclosure. As shown in FIG. 13, example 1300 includes one or more first monitoring occasions (e.g., occasion 1102a and occasion 1102b) and one or more second monitoring occasions (e.g., occasion 1106a and occasion 1106b). Although described in connection with two sets of monitoring occasions, the description similarly applies to additional sets of monitoring occasions (e.g., one or more third monitoring occasions, one or more fourth monitoring occasions, and so on).

In some aspects, as shown in FIG. 13, the one or more first monitoring occasions and/or the one or more second monitoring occasions may be periodic. A UE (e.g., UE 120) may monitor the one or more first monitoring occasions for a control channel (e.g., PDCCH) with a base station (e.g., base station 110).

In some aspects, the UE 120 may receive (e.g., from the base station 110) an indication of a change from a first TCI state to a second TCI state. For example, as shown in connection with reference number 1302, the base station 110 may activate (e.g., using a MAC-CE, DCI, and/or RRC signaling) the second TCI state. Accordingly, as shown by reference number 1304a, the UE 120 may apply a new spatial filter based at least in part on a second beam 1112 (e.g., formed as described above in connection with FIG. 3) defined by the second TCI state in lieu of a spatial filter based at least in part on a first beam 1108 (e.g., formed as described above in connection with FIG. 3) defined by the first TCI state. In some aspects, as shown in FIG. 13, the first TCI state may be associated with the one or more first control channel monitoring occasions, and the second TCI state may be associated with the one or more second control channel monitoring occasions.

Accordingly, as shown in FIG. 13, the UE 120 may monitor for messages from the base station 110 within the one or more second control channel monitoring occasions based at least in part on receiving the indication of the change from the first TCI state to the second TCI state. For example, as shown by reference number 1304b, the UE 120 may receive the activation and, based at least in part on the activation, change from monitoring the one or more first control channel monitoring occasions to monitoring the one or more second control channel monitoring occasions.

In some aspects, the UE 120 may receive (e.g., from the base station 110) a control message based at least in part on monitoring the one or more second control channel monitoring occasions. For example, the UE 120 may receive a PDCCH message within the one or more second control channel monitoring occasions that schedules data on an associated downlink channel (e.g., a PDSCH) with the base station 110.

In some aspects, a first search space that provides configurations for identifying the one or more first control channel monitoring occasions is associated with a first CORESET, and a second search space that provides configurations for identifying the one or more second control channel monitoring occasions is associated with a second CORESET. For example, the first CORESET may be indicated using a controlResourceSet data structure. Similarly, the second CORESET may be indicated using a controlResourceSet data structure. The controlResourceSet data structure may define CORESETs (e.g., using frequencyDomainResources, duration, and/or precoderGranularity variables) and include a list of TCI state identifiers (e.g., TCI-state-IDs) in a tci-StatesPDCCH-ToAddList data structure.

In some aspects, the first search space and the second search space may be defined in a data structure that associates an identifier of the first TCI state with the first search space and an identifier of the second TCI state with the second search space. For example, the data structure may be a SearchSpace data structure and may be transmitted by the base station 110, to the UE 120, via RRC signaling. As described herein, the SearchSpace data structure for the first search space may define the one or more first monitoring occasions (e.g., using monitoringSlotPeriodicityAndOffset, duration, and/or monitoringSymbolsWithinSlot variables) and include a list of associated TCI states including the first TCI state. Similarly, the SearchSpace data structure for the second search space may define the one or more second monitoring occasions (e.g., using monitoringSlotPeriodicityAndOffset, duration, and/or monitoringSymbolsWithinSlot variables) and include a list of associated TCI states including the second TCI state. For example, the SearchSpace data structure may include a list of TCI-state-IDs.

As an alternative, the first TCI state and the second TCI state are defined in a data structure that associates an identifier of the first search space with the first TCI state and an identifier of the second search space with the second TCI state. For example, the data structure may be a SearchSpace data structure and may be transmitted by the base station 110, to the UE 120, via RRC signaling. As described herein, the SearchSpace data structure for the first search space may define the one or more first monitoring occasions (e.g., using monitoringSlotPeriodicityAndOffset, duration, and/or monitoringSymbolsWithinSlot variables) and include a first identifier. Similarly, the SearchSpace data structure for the second search space may define the one or more second monitoring occasions (e.g., using monitoringSlotPeriodicityAndOffset, duration, and/or monitoringSymbolsWithinSlot variables) and include a second identifier. Moreover, the first and second TCI states may be indicated by a tci-StatesPDCCH-ToAddList data structure. The tci-StatesPDCCH-ToAddList may indicate corresponding TCI states as well as include identifiers for corresponding search spaces.

As further shown in FIG. 13, the UE 120 may monitor for messages from the base station 110 within the one or more first control channel monitoring occasions before receiving, from the base station 110, the activation of the second TCI state. Moreover, the UE 120 may monitor the one or more second control channel monitoring occasions in connection with a threshold time duration, after receiving the activation, being satisfied. For example, the threshold may be set to 2 ms, 3 ms, 4 ms, and so on. The threshold may be explicit (e.g., the UE 120 begins monitoring the one or more second control channel monitoring occasions only after expiry of a timer) and/or implicit (e.g., the UE 120 uses the threshold time duration to decode the indication and apply a new spatial filter based at least in part on the second TCI state). Additionally, or alternatively, the UE 120 may monitor the one or more second control channel monitoring occasions in connection with transmitting, to the base station 110, an acknowledgement (ACK) signal for the received indication of the change from the first TCI state to the second TCI state.

By using techniques as described in connection with FIG. 13, the base station 110 configures the UE 120 for a new TCI state and, using the same configuration, configures the UE 120 for a new group of monitoring occasions. The base station 110 conserves processing resources by avoiding re-determining whether the new TCI state interferes with other TCI states. Additionally, the base station 110 reduces signaling overhead by using a single downlink instance with the UE 120 to configure both the new TCI state and the new group of monitoring occasions. Additionally, the UE 120 experiences reduced latency and improved reliability and/or quality of communications with the base station 110, which conserves power and processing resources at the UE 120.

As indicated above, FIG. 13 is provided as an example. Other examples may differ from what is described with respect to FIG. 13.

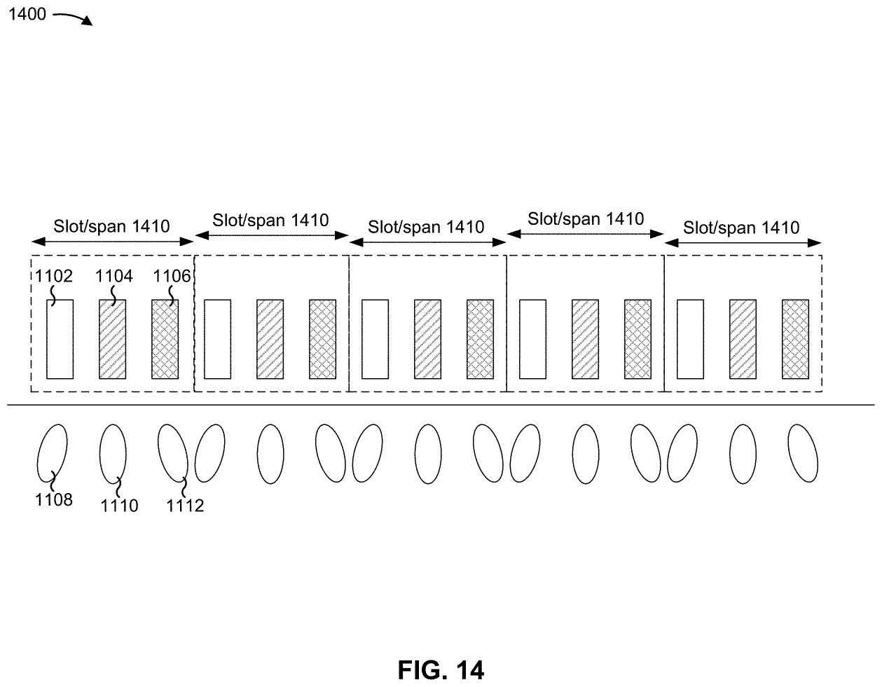

FIG. 14 is a diagram illustrating an example 1400 associated with control channel overbooking, in accordance with the present disclosure. As shown in FIG. 14, example 1400 includes one or more first monitoring occasions (e.g., occasion 1102), one or more second monitoring occasions (e.g., occasion 1104), and one or more third monitoring occasions (e.g., occasion 1106). Although described in connection with three sets of monitoring occasions, the description similarly applies to fewer sets of monitoring occasions (e.g., without the one or more third monitoring occasions) or additional sets of monitoring occasions (e.g., one or more fourth monitoring occasions, one or more fifth monitoring occasions, and so on).

In some aspects, as shown in FIG. 14, the one or more first monitoring occasions, the one or more second monitoring occasions, and/or the one or more third monitoring occasions may be periodic. A UE (e.g., UE 120) may monitor the one or more first monitoring occasions for a control channel (e.g., PDCCH) with a base station (e.g., base station 110).

In some aspects, the base station 110 may overbook monitoring occasions for the UE 120. For example, the base station 110 may configure more monitoring occasion candidates within a slot and/or a span 1410 than the UE 120 may monitor. For example, the UE 120 may lack antennas, processing resources, and/or other capabilities to monitor all of the monitoring occasion candidates. Accordingly, the UE 120 may monitor for messages from the base station 110 within a portion of candidates that are included in the one or more first monitoring occasions, the one or more second monitoring occasions, and/or the one or more third monitoring occasions.

In some aspects, the UE 120 may select the portion of candidates that are monitored based at least in part on candidates that are included in all search spaces across all possible TCI states (e.g., TCI states associated with first beam 1108, second beam 1110, and third beam 1112). Accordingly, the UE 120 may count all blind decodings (BDs) and/or control channel elements (CCEs) for monitoring occasion candidates in all search spaces across all TCI states. The UE 120 may select the portion of candidates that are monitored to limit the BDs and/or CCEs within a capability of the UE 120.

As an alternative, the UE 120 may select the portion of candidates that are monitored based at least in part on candidates that are included in all search spaces associated with the second TCI state (e.g., associated with the second beam 1110). Accordingly, the UE 120 may count all BDs and/or CCEs for monitoring occasion candidates associated with a TCI state that the UE 120 is actively using (e.g., by applying a spatial filter based at least in part on the TCI state). The UE 120 may select the portion of candidates that are monitored to limit the BDs and/or CCEs within a capability of the UE 120.

As another alternative, the UE 120 may select the portion of candidates that are monitored based at least in part on a largest number of candidates that are included in a span and that are largest amongst all possible TCI states associated with the span. Accordingly, the UE 120 may count a largest number of BDs and/or CCEs for monitoring occasion candidates associated with a search space including a largest number of monitoring occasions, where this search space is selected from all search spaces across all TCI states. The UE 120 may select the portion of candidates that are monitored to limit the BDs and/or CCEs within a capability of the UE 120.

By using techniques as described in connection with FIG. 14, the base station 110 may overbook the PDCCH or other control channel. Accordingly, the base station 110 may consume fewer processing resources. Additionally, the UE 120 may reduce latency by monitoring a subset of the overbooked monitoring occasions.

As indicated above, FIG. 14 is provided as an example. Other examples may differ from what is described with respect to FIG. 14.

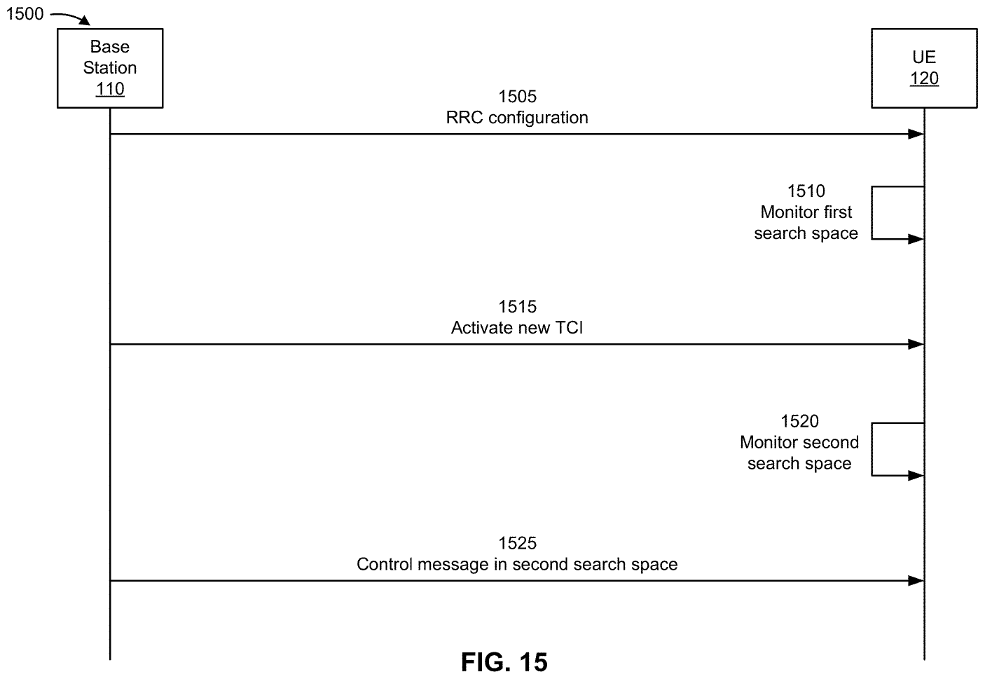

FIG. 15 is a diagram illustrating an example 1500 associated with beam and search space correspondence for downlink transmissions, in accordance with the present disclosure. As shown in FIG. 15, example 1500 includes communication between a base station 110 and a UE 120. In some aspects, the base station 110 and the UE 120 may be included in a wireless network, such as wireless network 100.

In some aspects, the base station 110 may transmit, and the UE 120 may receive, an indication of one or more first control channel monitoring occasions (e.g., a PDCCH). For example, and as shown in connection with reference number 1505, the base station 110 may use an RRC configuration to indicate the one or more first monitoring occasions. Additionally, the base station 110 may transmit (e.g., using RRC signaling) an indication of a first beam (e.g., formed as described above in connection with FIG. 3) associated with the one or more first monitoring occasions.

As shown in connection with reference number 1510, the UE 120 may monitor for messages from the base station 110 within a first search space including the one or more first control channel monitoring occasions. For example, the UE 120 may monitor for PDCCH messages from the base station 110.

In some aspects, the base station 110 may transmit, and the UE 120 may receive, an indication of a change from a first TCI state to a second TCI state. For example, as shown in connection with reference number 1515, the base station 110 may transmit, and the UE 120 may receive, an activation of the second TCI state. In some aspects, the first TCI state may be associated with the one or more first control channel monitoring occasions, and the second TCI state may be associated with one or more second control channel monitoring occasions different than the one or more first control channel monitoring occasions.

As described above in connection with FIG. 13, a first search space that provides configurations for identifying the one or more first control channel monitoring occasions may be associated with a first CORESET, and a second search space that provides configurations for identifying the one or more second control channel monitoring occasions may be associated with a second CORESET. For example, as described above, the first CORESET may be indicated (e.g., using RRC signaling from the base station 110) using a controlResourceSet data structure, and the second CORESET may be indicated (e.g., using RRC signaling from the base station 110) using a controlResourceSet data structure.

Accordingly, as described above in connection with FIG. 13, the first search space and the second search space may be defined in a data structure that associates an identifier of the first TCI state with the first search space and an identifier of the second TCI state with the second search space. For example, as described above, the data structure may be a SearchSpace data structure and may be transmitted by the base station 110, to the UE 120, via RRC signaling. The SearchSpace data structure for the first search space may define the one or more first monitoring occasions (e.g., using monitoringSlotPeriodicityAndOffset, duration, and/or monitoringSymbolsWithinSlot, variables) and may include a list of associated TCI states (e.g., a list of TCI-state-IDs) including the first TCI state. Similarly, the SearchSpace data structure for the second search space may define the one or more second monitoring occasions (e.g., using monitoringSlotPeriodicityAndOffset, duration, and/or monitoringSymbolsWithinSlot variables) and may include a list of associated TCI states (e.g., a list of TCI-state-IDs) with the second TCI state.

As an alternative, and as described above in connection with FIG. 13, the first TCI state and the second TCI state may be defined in a data structure that associates an identifier of the first search space with the first TCI state and an identifier of the second search space with the second TCI state. For example, as described above, the data structure may be a SearchSpace data structure and may be transmitted by the base station 110, to the UE 120, via RRC signaling. The SearchSpace data structure for the first search space may define the one or more first monitoring occasions (e.g., using monitoringSlotPeriodicityAndOffset, duration, and/or monitoringSymbolsWithinSlot variables) and may include a first identifier. Similarly, the SearchSpace data structure for the second search space may define the one or more second monitoring occasions (e.g., using monitoringSlotPeriodicityAndOffset, duration, and/or monitoringSymbolsWithinSlot variables) and include a second identifier. Moreover, the first and second TCI states may be indicated by a tci-StatesPDCCH-ToAddList. The tci-StatesPDCCH-ToAddList may indicate corresponding TCI states as well as include identifiers for corresponding search spaces.

As shown in connection with reference number 1520, the UE 120 may monitor for messages from the base station 110 within a second search space including the one or more second control channel monitoring occasions, based at least in part on receiving the indication of the change from the first TCI state to the second TCI state. For example, the UE 120 may receive, from the base station 110, a MAC-CE, DCI, and/or RRC signaling that activates the second TCI state and, based at least in part on the activation, change from monitoring the one or more first control channel monitoring occasions to monitoring the one or more second control channel monitoring occasions. The UE 120 may also apply a new spatial filter based at least in part on a second beam (e.g., formed as described above in connection with FIG. 3) defined by the second TCI state in lieu of a spatial filter based at least in part on a first beam (e.g., formed as described above in connection with FIG. 3) defined by the first TCI state.

In some aspects, the base station 110 may overbook the UE 120. Accordingly, as described above in connection with FIG. 14, the UE 120 may monitor for messages from the base station 110 within a portion of candidates that are included in the one or more second control channel monitoring occasions. As an alternative, the base station 110 may refrain from overbooking such that the UE 120 is never provided more monitoring occasion candidates than exceeds a capability of the UE 120.

In some aspects, the base station 110 may additionally transmit, and the UE 120 may additionally receive, an indication of an additional search space. For example, the additional search space may be a legacy search space (e.g., associated with an earlier release of 3GPP specifications than the one or more first control channel monitoring occasions and/or the one or more second control channel monitoring occasions). Accordingly, the UE 120 may additionally monitor for messages from the base station 110 within the legacy search space. In some aspects, the messages within the legacy search space may be unicast messages, and the messages within the one or more first control channel monitoring occasions and/or the one or more second control channel monitoring occasions may be multicast messages.

In some aspects, the unicast messages may be time division multiplexed with the multicast messages and/or frequency division multiplexed with the multicast messages. Accordingly, the UE 120 may monitor both the one or more second control channel monitoring occasions and the legacy search space. As an alternative, the legacy search space and the one or more second control channel monitoring occasions may share a source reference signal (e.g., an SSB and/or a CSI-RS), and the UE 120 may monitor both the one or more second control channel monitoring occasions and the legacy search space. For example, the control channel for the one or more second control channel monitoring occasions and the control channel for the legacy search space may be quasi-co-located with the same SSB and/or other reference signal.

As an alternative, the UE 120 may monitor the legacy search space or the one or more second control channel monitoring occasions based at least in part on applying one or more stored rules. For example, the UE 120 may prioritize the one or more second control channel monitoring occasions over the legacy search space, and/or the UE 120 may monitor whichever of the legacy search space or the one or more second control channel monitoring occasions has a lowest associated search space index. In some aspects, the UE 120 may receive the rules (e.g., via RRC signaling) from the base station 110, and/or the rules may be programmed (and/or otherwise preconfigured) into the UE 120.

In some aspects, and as described above in connection with FIG. 13, the UE 120 may monitor the one or more second control channel monitoring occasions in connection with a threshold time duration, after receiving the indication of the change from the first TCI state to the second TCI state, being satisfied. As explained above, the threshold may be explicit and/or implicit.

In some aspects, the UE 120 may be in an idle mode or an inactive state. Accordingly, the one or more second control channel monitoring occasions may be associated with a source reference signal (e.g., an SSB), and the UE 120 may monitor the one or more second control channel monitoring occasions based at least in part on a strength of the source reference signal. For example, the UE 120 may select the source reference signal with the highest RSRP, highest CQI, and/or other highest measurement and monitor the one or more second control channel monitoring occasions associated with a control channel quasi-co-located with the selected source reference signal.

As shown in connection with reference number 1525, the base station 110 may transmit, and the UE 120 may receive, a control message within the one or more second control channel monitoring occasions. For example, the UE 120 may receive a PDCCH message within the one or more second control channel monitoring occasions that schedules data on an associated downlink channel (e.g., a PDSCH) with the base station 110.

By using techniques as described in connection with FIG. 15, the base station 110 may configure the UE 120 for a new TCI state and, using the same configuration, configure the UE 120 for a new group of monitoring occasions. The base station 110 conserves processing resources by avoiding re-determining whether the new TCI state interferes with other TCI states. Additionally, the base station 110 may reduce signaling overhead by using a single downlink instance with the UE 120 to configure both the new TCI state and the new group of monitoring occasions. The UE 120 experiences reduced latency and improved reliability and/or quality of communications with the base station 110.

As indicated above, FIG. 15 is provided as an example. Other examples may differ from what is described with respect to FIG. 15.

FIG. 16 is a diagram illustrating an example process 1600 performed, for example, by a UE, in accordance with the present disclosure. Example process 1600 is an example where the UE (e.g., UE 120 and/or apparatus 2000 of FIG. 20) performs operations associated with beam-based initial transmissions and re-transmissions.

As shown in FIG. 16, in some aspects, process 1600 may include receiving, from a base station (e.g., base station 110 and/or apparatus 2100 of FIG. 21), an indication of a first search space for control messages from the base station and an indication of a first downlink beam for the first search space (block 1610). For example, the UE (e.g., using reception component 2002, depicted in FIG. 20) may receive an indication of a first search space for control messages from the base station and an indication of a first downlink beam for the first search space, as described herein.

As further shown in FIG. 16, in some aspects, process 1600 may include receiving, from the base station, an indication of a second search space for control messages from the base station and an indication of a second downlink beam for the second search space (block 1620). For example, the UE (e.g., using reception component 2002) may receive an indication of a second search space for control messages from the base station and an indication of a second downlink beam for the second search space, as described herein.

As further shown in FIG. 16, in some aspects, process 1600 may include monitoring the first search space, using a spatial filter based at least in part on the first downlink beam, for an initial transmission of data from the base station (block 1630). For example, the UE (e.g., using monitoring component 2008, depicted in FIG. 20 may monitor the first search space, using a spatial filter based at least in part on the first downlink beam, for an initial transmission of data from the base station, as described herein.

As further shown in FIG. 16, in some aspects, process 1600 may include monitoring the second search space, using a spatial filter based at least in part on the second downlink beam, for a re-transmission of the data from the base station (block 1640). For example, the UE (e.g., using monitoring component 2008) may monitor the second search space, using a spatial filter based at least in part on the second downlink beam, for a re-transmission of the data from the base station, as described herein.

Process 1600 may include additional aspects, such as any single aspect or any combination of aspects described below and/or in connection with one or more other processes described elsewhere herein.

In a first aspect, the first downlink beam is associated with a first TCI state, and the second downlink beam is associated with a second TCI.

In a second aspect, alone or in combination with the first aspect, the first search space is associated with a first CORESET, and the second search space is associated with a second CORESET.

In a third aspect, alone or in combination with one or more of the first and second aspects, the first search space is a search space common to a group of UEs including the UE.

In a fourth aspect, alone or in combination with one or more of the first through third aspects, the first search space is monitored for DCI scrambled with a group identifier associated with the group of UEs including the UE.

In a fifth aspect, alone or in combination with one or more of the first through fourth aspects, the second search space is a search space common to a group of UEs including the UE.

In a sixth aspect, alone or in combination with one or more of the first through fifth aspects, the second search space is monitored for DCI scrambled with a group identifier associated with the group of UEs including the UE.

In a seventh aspect, alone or in combination with one or more of the first through sixth aspects, the second search space is a search space specific to the UE.

In an eighth aspect, alone or in combination with one or more of the first through seventh aspects, the second search space is monitored for DCI scrambled with a specific identifier associated with the UE.

In a ninth aspect, alone or in combination with one or more of the first through eighth aspects, process 1600 further includes detecting an error when attempting to decode a message (e.g., using decoding component 2010, depicted in FIG. 20) that was received while monitoring the first search space, such that the second search space is monitored based at least in part on detecting the decoding error.

In a tenth aspect, alone or in combination with one or more of the first through ninth aspects, process 1600 further includes receiving (e.g., using reception component 2002), from the base station, information activating the second search space, such that the second search space is monitored based at least in part on receiving the information activating the second search space.

In an eleventh aspect, alone or in combination with one or more of the first through tenth aspects, the information activating the second search space includes at least one of a MAC-CE or DCI.

In a twelfth aspect, alone or in combination with one or more of the first through eleventh aspects, process 1600 further includes detecting an error when attempting to decode a message (e.g., using decoding component 2010) that was received while monitoring the first search space; and transmitting (e.g., using transmission component 2004, depicted in FIG. 20), to the base station, a signal indicating the decoding error, such that the information activating the second search space is received based at least in part on transmitting the signal indicating the decoding error.

In a thirteenth aspect, alone or in combination with one or more of the first through twelfth aspects, process 1600 further includes determining (e.g., using determination component 2012, depicted in FIG. 20) that the second downlink beam is preferred to one or more additional downlink beams, such that the second search space is monitored based at least in part on determining that the second downlink beam is preferred to the one or more additional downlink beams.

In a fourteenth aspect, alone or in combination with one or more of the first through thirteenth aspects, determining that the second downlink beam is preferred to the one or more additional downlink beams is based at least in part on a signal strength of the second downlink beam, an interference strength of the second downlink beam, or a quality indicator associated with the second downlink beam.

In a fifteenth aspect, alone or in combination with one or more of the first through fourteenth aspects, process 1600 further includes detecting an error when attempting to decode a message (e.g., using decoding component 2010) that was received while monitoring the first search space; and transmitting (e.g., using transmission component 2004), to the base station, information related to a strength of the second downlink beam, such that the second search space is monitored in connection with transmitting the information related to the strength of the second downlink beam.

In a sixteenth aspect, alone or in combination with one or more of the first through fifteenth aspects, the indication of the first search space includes a data structure that includes a list of associated TCI states that include a TCI state for the first downlink beam.

In a seventeenth aspect, alone or in combination with one or more of the first through sixteenth aspects, the indication of the first search space includes a data structure that includes an identifier, where the identifier is associated with one or more TCI states that include a TCI state for the first downlink beam.

In an eighteenth aspect, alone or in combination with one or more of the first through seventeenth aspects, process 1600 further includes decoding (e.g., using decoding component 2010) a message from the base station by soft-combining a signal scheduled by DCI received in the first search space with an additional signal scheduled by DCI received in the second search space.

In a nineteenth aspect, alone or in combination with one or more of the first through eighteenth aspects, process 1600 further includes receiving (e.g., using reception component 2002), from the base station, an indication of a third search space for control messages from the base station and an indication of a third downlink beam for the third search space; monitoring (e.g., using monitoring component 2008) the third search space, using a spatial filter based at least in part on the third downlink beam, for a re-transmission of the data from the base station; and decoding (e.g., using decoding component 2010) a message from the base station by soft-combining a signal scheduled by DCI received in the second search space with an additional signal scheduled by DCI received in the third search space.

In a twentieth aspect, alone or in combination with one or more of the first through nineteenth aspects, process 1600 further includes detecting an error when attempting to decode a message (e.g., using decoding component 2010) that was received while monitoring the second search space; and transmitting (e.g., using transmission component 2004), to the base station, a signal indicating the decoding error, where the signal indicating the decoding error is transmitted on an uplink resource associated with the second search space.

In a twenty-first aspect, alone or in combination with one or more of the first through twentieth aspects, process 1600 further includes receiving (e.g., using reception component 2002), from the base station, an indication of a third search space for control messages from the base station and an indication of a third downlink beam for the third search space; detecting an error when attempting to decode a message (e.g., using decoding component 2010) that was received while monitoring the second search space; and transmitting (e.g., using transmission component 2004), to the base station, a signal indicating the decoding error, where the signal indicating the decoding error is transmitted on an uplink resource associated with the third search space.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a base station, in accordance with the present disclosure. Example process 1700 is an example where the base station (e.g., base station 110 and/or apparatus 2100 of FIG. 21) performs operations associated with beam-based initial transmissions and re-transmissions.

As shown in FIG. 17, in some aspects, process 1700 may include transmitting, to a UE (e.g., UE 120 and/or apparatus 2000 of FIG. 20), an indication of a first search space for control messages from the base station and an indication of a first downlink beam for the first search space (block 1710). For example, the base station (e.g., using transmission component 2104, depicted in FIG. 21) may transmit an indication of a first search space for control messages from the base station and an indication of a first downlink beam for the first search space, as described herein.

As further shown in FIG. 17, in some aspects, process 1700 may include transmitting, to the UE, an indication of a second search space for control messages from the base station and an indication of a second downlink beam for the second search space (block 1720). For example, the base station (e.g., using transmission component 2104) may transmit an indication of a second search space for control messages from the base station and an indication of a second downlink beam for the second search space, as described herein.

As further shown in FIG. 17, in some aspects, process 1700 may include sending an initial transmission of data within the first search space and using the first downlink beam (block 1730). For example, the base station (e.g., using transmission component 2104) may send an initial transmission of data within the first search space and using the first downlink beam, as described herein.

As further shown in FIG. 17, in some aspects, process 1700 may include sending a re-transmission of the data within the second search space and using the second downlink beam (block 1740). For example, the base station (e.g., using transmission component 2104) may send a re-transmission of the data within the second search space and using the second downlink beam, as described herein.

Process 1700 may include additional aspects, such as any single aspect or any combination of aspects described below and/or in connection with one or more other processes described elsewhere herein.

In a first aspect, the first downlink beam is associated with a first TCI state, and the second downlink beam is associated with a second TCI state.

In a second aspect, alone or in combination with the first aspect, the first search space is associated with a first CORESET, and the second search space is associated with a second CORESET.

In a third aspect, alone or in combination with one or more of the first and second aspects, the first search space is a search space common to a group of UEs including the UE.

In a fourth aspect, alone or in combination with one or more of the first through third aspects, the initial transmission is scheduled by transmitting, in the first search space, DCI scrambled with a group identifier associated with the group of UEs including the UE.

In a fifth aspect, alone or in combination with one or more of the first through fourth aspects, the second search space is a search space common to a group of UEs including the UE.

In a sixth aspect, alone or in combination with one or more of the first through fifth aspects, the re-transmission is scheduled by transmitting, in the second search space, DCI scrambled with a group identifier associated with the group of UEs including the UE.

In a seventh aspect, alone or in combination with one or more of the first through sixth aspects, the second search space is a search space specific to the UE.

In an eighth aspect, alone or in combination with one or more of the first through seventh aspects, the re-transmission is scheduled by transmitting, in the second search space, DCI scrambled with a specific identifier associated with the UE.

In a ninth aspect, alone or in combination with one or more of the first through eighth aspects, process 1700 further includes transmitting (e.g., using transmission component 2104), to the UE, information activating the second search space.

In a tenth aspect, alone or in combination with one or more of the first through ninth aspects, the information activating the second search space includes at least one of a MAC-CE or DCI.

In an eleventh aspect, alone or in combination with one or more of the first through tenth aspects, process 1700 further includes receiving (e.g., using reception component 2102, depicted in FIG. 21), from the UE, a signal indicating an error in decoding a message that was transmitted in the first search space, such that the information activating the second search space is transmitted based at least in part on receiving the signal indicating the decoding error.

In a twelfth aspect, alone or in combination with one or more of the first through eleventh aspects, process 1700 further includes determining (e.g., using determination component 2108, depicted in FIG. 21) that the second downlink beam is preferred to one or more additional downlink beams, such that the information activating the second search space is transmitted based at least in part on determining that the second downlink beam is preferred to the one or more additional downlink beams.

In a thirteenth aspect, alone or in combination with one or more of the first through twelfth aspects, determining that the second downlink beam is preferred to the one or more additional downlink beams is based at least in part on a signal strength of the second downlink beam, an interference strength of the second downlink beam, or a quality indicator associated with the second downlink beam.

In a fourteenth aspect, alone or in combination with one or more of the first through thirteenth aspects, process 1700 further includes receiving (e.g., using reception component 2102), from the UE, information related to a strength of the second downlink beam, such that the information activating the second search space is transmitted based at least in part on receiving the information related to the strength of the second downlink beam.

In a fifteenth aspect, alone or in combination with one or more of the first through fourteenth aspects, the indication of the first search space is a data structure that includes a list of associated TCI states that include a TCI state for the first downlink beam.

In a sixteenth aspect, alone or in combination with one or more of the first through fifteenth aspects, the indication of the first search space is a data structure that includes an identifier, wherein the identifier is associated with one or more TCI states that include a TCI state for the first downlink beam.

In a seventeenth aspect, alone or in combination with one or more of the first through sixteenth aspects, process 1700 further includes transmitting (e.g., using transmission component 2104), to the UE, an indication of a third search space for control messages from the base station and an indication of a third downlink beam for the third search space; and sending (e.g., using transmission component 2104) a re-transmission of the data within the third search space and using the third downlink beam.

In an eighteenth aspect, alone or in combination with one or more of the first through seventeenth aspects, process 1700 further includes receiving (e.g., using reception component 2102), from the UE, a signal indicating an error in decoding a message that was transmitted in the second search space, where the signal indicating the decoding error is received on an uplink resource associated with the second search space.

In a nineteenth aspect, alone or in combination with one or more of the first through eighteenth aspects, process 1700 further includes transmitting (e.g., using transmission component 2104), to the UE, an indication of a third search space for control messages from the base station and an indication of a third downlink beam for the third search space; and receiving (e.g., using reception component 2102), from the UE, a signal indicating an error in decoding a message that was transmitted in the second search space, where the signal indicating the decoding error is received on an uplink resource associated with the third search space.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, by a UE, in accordance with the present disclosure. Example process 1800 is an example where the UE (e.g., UE 120 and/or apparatus 2000 of FIG. 20) performs operations associated with beam and search space correspondence for downlink transmissions.

As shown in FIG. 18, in some aspects, process 1800 may include receiving, from a base station (e.g., base station 110 and/or apparatus 2100 of FIG. 21), an indication of a change from a first TCI state to a second TCI state (block 1810). For example, the UE (e.g., using reception component 2002, depicted in FIG. 20) may receive an indication of a change from a first TCI state to a second TCI state, as described herein. In some aspects, the first TCI state is associated with one or more first control channel monitoring occasions, and the second TCI state is associated with one or more second control channel monitoring occasions different than the one or more first control channel monitoring occasions.

As further shown in FIG. 18, in some aspects, process 1800 may include monitoring for messages from the base station within the one or more second control channel monitoring occasions based at least in part on receiving the indication of the change from the first TCI state to the second TCI state (block 1820). For example, the UE (e.g., using monitoring component 2008, depicted in FIG. 20) may monitor for messages within the one or more second control channel monitoring occasions based at least in part on receiving the indication of the change from the first TCI state to the second TCI state, as described herein.

As further shown in FIG. 18, in some aspects, process 1800 may include receiving, from the base station, a control message based at least in part on monitoring the one or more second control channel monitoring occasions (block 1830). For example, the UE (e.g., using reception component 2002) may receive a control message based at least in part on monitoring the one or more second control channel monitoring occasions, as described herein.

Process 1800 may include additional aspects, such as any single aspect or any combination of aspects described below and/or in connection with one or more other processes described elsewhere herein.

In a first aspect, a first search space that provides configurations for identifying the one or more first control channel monitoring occasions is associated with a first CORESET, and a second search space that provides configurations for identifying the one or more second control channel monitoring occasions is associated with a second CORESET.

In a second aspect, alone or in combination with the first aspect, the first search space and the second search space are defined in a data structure that associates an identifier of the first TCI state with the first search space and an identifier of the second TCI state with the second search space.

In a third aspect, alone or in combination with one or more of the first and second aspects, the first TCI state and the second TCI state are defined in a data structure that associates an identifier of the first search space with the first TCI state and an identifier of the second search space with the second TCI state.

In a fourth aspect, alone or in combination with one or more of the first through third aspects, process 1800 further includes receiving (e.g., using reception component 2002), from the base station, an indication of an additional search space; and monitoring (e.g., using monitoring component 2008) for messages from the base station within the additional search space, the messages within the additional search space being unicast messages, and the messages within the one or more second control channel monitoring occasions being multicast messages.

In a fifth aspect, alone or in combination with one or more of the first through fourth aspects, the unicast messages are time division multiplexed with the multicast messages.

In a sixth aspect, alone or in combination with one or more of the first through fifth aspects, the additional search space or the one or more second control channel monitoring occasions are monitored based at least in part on applying one or more stored rules.

In a seventh aspect, alone or in combination with one or more of the first through sixth aspects, the additional search space and the one or more second control channel monitoring occasions share a source reference signal, and both the one or more second control channel monitoring occasions and the additional search space are monitored.

In an eighth aspect, alone or in combination with one or more of the first through seventh aspects, the unicast messages are frequency division multiplexed with the multicast messages.

In a ninth aspect, alone or in combination with one or more of the first through eighth aspects, monitoring for messages from the base station within the one or more second control channel monitoring occasions includes monitoring (e.g., using monitoring component 2008) for messages from the base station within a portion of candidates that are included in the one or more second control channel monitoring occasions.

In a tenth aspect, alone or in combination with one or more of the first through ninth aspects, the portion of candidates included in the one or more second control channel monitoring occasions that are monitored are selected based at least in part on candidates that are included in all search spaces across all possible TCI states.

In an eleventh aspect, alone or in combination with one or more of the first through tenth aspects, the portion of candidates included in the one or more second control channel monitoring occasions that are monitored are selected based at least in part on candidates that are included in all search spaces associated with the second TCI state.

In a twelfth aspect, alone or in combination with one or more of the first through eleventh aspects, the portion of candidates included in the one or more second control channel monitoring occasions that are monitored are selected based at least in part on a largest number of candidates that are included in a span and that are largest amongst all possible TCI states associated with the span.

In a thirteenth aspect, alone or in combination with one or more of the first through twelfth aspects, process 1800 further includes monitoring (e.g., using monitoring component 2008) for messages from the base station within the one or more first control channel monitoring occasions before receiving the indication of the change from the first TCI state to the second TCI state, the one or more second control channel monitoring occasions being monitored in connection with a threshold time duration, after receiving the indication of the change from the first TCI state to the second TCI state, being satisfied.

In a fourteenth aspect, alone or in combination with one or more of the first through thirteenth aspects, the UE is in an idle mode or an inactive state, the one or more second control channel monitoring occasions are associated with a source reference signal, and the one or more second control channel monitoring occasions are monitored based at least in part on a strength of the source reference signal.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram illustrating an example process 1900 performed, for example, by a base station, in accordance with the present disclosure. Example process 1900 is an example where the base station (e.g., base station 110 and/or apparatus 2100 of FIG. 21) performs operations associated with beam and search space correspondence for downlink transmissions.

As shown in FIG. 19, in some aspects, process 1900 may include transmitting, to a UE (e.g., UE 120 and/or apparatus 2000 of FIG. 20), an indication of a change from a first TCI state to a second TCI state (block 1910). For example, the base station (e.g., using transmission component 2104, depicted in FIG. 21) may transmit an indication of a change from a first TCI state to a second TCI state, as described herein. In some aspects, the first TCI state is associated with one or more first control channel monitoring occasions, and the second TCI state is associated with one or more second control channel monitoring occasions different than the one or more first control channel monitoring occasions.

As further shown in FIG. 19, in some aspects, process 1900 may include transmitting, to the UE, a control message within the one or more second control channel monitoring occasions based at least in part on transmitting the indication of the change from the first TCI state to the second TCI state (block 1920). For example, the base station (e.g., using transmission component 2104) may transmit a control message within the one or more second control channel monitoring occasions based at least in part on transmitting the indication of the change from the first TCI state to the second TCI state, as described herein.

Process 1900 may include additional aspects, such as any single aspect or any combination of aspects described below and/or in connection with one or more other processes described elsewhere herein.

In a first aspect, a first search space that provides configurations for identifying the one or more first control channel monitoring occasions is associated with a first CORESET, and a second search space that provides configurations for identifying the one or more second control channel monitoring occasions is associated with a second CORESET.

In a second aspect, alone or in combination with the first aspect, the first search space and the second search space are defined in a data structure that associates an identifier of the first TCI state with the first search space and an identifier of the second TCI state with the second search space.

In a third aspect, alone or in combination with one or more of the first and second aspects, the first TCI state and the second TCI state are defined in a data structure that associates an identifier of the first search space with the first TCI state and an identifier of the second search space with the second TCI state.

In a fourth aspect, alone or in combination with one or more of the first through third aspects, process 1900 further includes transmitting (e.g., using transmission component 2104), to the UE, an indication of an additional search space; and transmitting (e.g., using transmission component 2104), to the UE, another control message within the additional search space, the control message within the additional search space being a unicast message, and the control message within the second search space being a multicast message.

In a fifth aspect, alone or in combination with one or more of the first through fourth aspects, the unicast message is time division multiplexed with the multicast message.

In a sixth aspect, alone or in combination with one or more of the first through fifth aspects, the second search space and the additional search space share a source reference signal.

In a seventh aspect, alone or in combination with one or more of the first through sixth aspects, the unicast message is frequency division multiplexed with the multicast message.

In an eighth aspect, alone or in combination with one or more of the first through seventh aspects, transmitting the control message within the second search space comprises transmitting (e.g., using transmission component 2104) the control message within a portion of candidates that are included in the second search space.

In a ninth aspect, alone or in combination with one or more of the first through eighth aspects, the portion of candidates included in the second search space that are monitored are selected based at least in part on candidates that are included in all search spaces across all possible TCI states.

In a tenth aspect, alone or in combination with one or more of the first through ninth aspects, the portion of candidates included in the second search space that are monitored are selected based at least in part on candidates that are included in all search spaces associated with the second TCI state.

In an eleventh aspect, alone or in combination with one or more of the first through tenth aspects, the portion of candidates included in the second search space that are monitored are selected based at least in part on a largest number of candidates that are included in a span and that are largest amongst all possible TCI states associated with the span.

In a twelfth aspect, alone or in combination with one or more of the first through eleventh aspects, process 1900 further includes transmitting (e.g., using transmission component 2104) the control message within the one or more first control channel monitoring occasions before transmitting the indication of the change from the first TCI state to the second TCI state, the control message being transmitted within the one or more second control channel monitoring occasions in connection with a threshold time duration, after transmitting the indication of the change from the first TCI state to the second TCI state, being satisfied.

Although FIG. 19 shows example blocks of process 1900, in some aspects, process 1900 may include additional blocks, fewer blocks, different blocks, or differently arranged blocks than those depicted in FIG. 19. Additionally, or alternatively, two or more of the blocks of process 1900 may be performed in parallel.

FIG. 20 is a block diagram of an example apparatus 2000 for wireless communication. The apparatus 2000 may be a UE, or a UE may include the apparatus 2000. In some aspects, the apparatus 2000 includes a reception component 2002 and a transmission component 2004, which may be in communication with one another (for example, via one or more buses and/or one or more other components). As shown, the apparatus 2000 may communicate with another apparatus 2006 (such as a UE, a base station, or another wireless communication device) using the reception component 2002 and the transmission component 2004. As further shown, the apparatus 2000 may include one or more of a monitoring component 2008, a decoding component 2010, or a determination component 2012, among other examples.

In some aspects, the apparatus 2000 may be configured to perform one or more operations described herein in connection with FIGS. 4-11 and/or 13-21. Additionally, or alternatively, the apparatus 2000 may be configured to perform one or more processes described herein, such as process 1600 of FIG. 16, process 1800 of FIG. 18, or a combination thereof. In some aspects, the apparatus 2000 and/or one or more components shown in FIG. 20 may include one or more components of the UE described above in connection with FIG. 2. Additionally, or alternatively, one or more components shown in FIG. 20 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2002 may receive communications, such as reference signals, control information, data communications, or a combination thereof, from the apparatus 2006. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, a modem, a MIMO detector, a receive processor, a controller/processor, a memory, or a combination thereof, of the UE described above in connection with FIG. 2.

The transmission component 2004 may transmit communications, such as reference signals, control information, data communications, or a combination thereof, to the apparatus 2006. In some aspects, one or more other components of the apparatus 2000 may generate communications and may provide the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, a modem, a transmit MIMO processor, a transmit processor, a controller/processor, a memory, or a combination thereof, of the UE described above in connection with FIG. 2. In some aspects, the transmission component 2004 may be co-located with the reception component 2002 in a transceiver.

In some aspects, the reception component 2002 may receive, from the apparatus 2006, an indication of a first search space for control messages from the apparatus 2006 and an indication of a first downlink beam for the first search space. The reception component 2002 may further receive, from the apparatus 2006, an indication of a second search space for control messages from the apparatus 2006 and an indication of a second downlink beam for the second search space. Additionally, the monitoring component 2008 may monitor the first search space, using a spatial filter based at least in part on the first downlink beam, for an initial transmission of data from the apparatus 2006. In some aspects, the monitoring component 2008 may include one or more antennas, a modem, a MIMO detector, a receive processor, a modem, a transmit MIMO processor, a transmit processor, a controller/processor, a memory, or a combination thereof, of the UE described above in connection with FIG. 2. The monitoring component 2008 may further monitor the second search space, using a spatial filter based at least in part on the second downlink beam, for re-transmission of the data from the apparatus 2006.

In some aspects, the decoding component 2010 may detect an error when attempting to decode a message that was received while monitoring the first search space. Accordingly, the monitoring component 2008 may monitor the second search space based at least in part on the decoding component 2010 detecting the decoding error. In some aspects, the decoding component 2010 may include one or more antennas, a modem, a MIMO detector, a receive processor, a modem, a transmit MIMO processor, a transmit processor, a controller/processor, a memory, or a combination thereof, of the UE described above in connection with FIG. 2.

In some aspects, the reception component 2002 may receive, from the apparatus 2006, information activating the second search space. Accordingly, the monitoring component 2008 may monitor the second search space based at least in part on the reception component 2002 receiving the information activating the second search space.

In some aspects, as described above, the decoding component 2010 may detect an error when attempting to decode a message that was received while monitoring the first search space. Accordingly, the transmission component 2004 may transmit, to the apparatus 2006, a signal indicating the decoding error. The reception component 2002 may receive the information activating the second search space based at least in part on the transmission component 2004 transmitting the signal indicating the decoding error.

In some aspects, the determination component 2012 may determine that the second downlink beam is preferred to one or more additional downlink beams. Accordingly, the monitoring component 2008 may monitor the second search space based at least in part on the determination component 2012 determining that the second downlink beam is preferred to the one or more additional downlink beams. In some aspects, the determination component 2012 may include a MIMO detector, a receive processor, a modem, a transmit MIMO processor, a transmit processor, a controller/processor, a memory, or a combination thereof, of the UE described above in connection with FIG. 2.

In some aspects, as described above, the decoding component 2010 may detect an error when attempting to decode a message that was received while monitoring the first search space. Accordingly, the transmission component 2004 may transmit, to the apparatus 2006, information related to a strength of the second downlink beam. The monitoring component 2008 may monitor the second search space in connection with the transmission component 2004 transmitting the information related to the strength of the second downlink beam.

In some aspects, the decoding component 2010 may decode a message from the apparatus 2006 by soft-combining a signal scheduled by DCI received (e.g., by the reception component 2002) in the first search space with an additional signal scheduled by DCI received (e.g., by the reception component 2002) in the second search space.

In some aspects, the reception component 2002 may receive, from the apparatus 2006, an indication of a third search space for control messages from the apparatus 2006 and an indication of a third downlink beam for the third search space. Accordingly, the monitoring component 2008 may monitor the third search space, using a spatial filter based at least in part on the third downlink beam, for a re-transmission of the data from the apparatus 2006.

In some aspects, the decoding component 2010 may decode a message from the apparatus 2006 by soft-combining a signal scheduled by DCI received (e.g., by the reception component 2002) in the second search space with an additional signal scheduled by DCI received (e.g., by the reception component 2002) in the third search space.

In some aspects, the decoding component 2010 may detect an error when attempting to decode a message that was received while monitoring the second search space. Accordingly, the transmission component 2004 may transmit, to the apparatus 2006, a signal indicating the decoding error on an uplink resource associated with the second search space. As an alternative, the transmission component 2004 may transmit, to the apparatus 2006, a signal indicating the decoding error on an uplink resource associated with the third search space.

Additionally, or alternatively, the reception component 2002 may receive, from the apparatus 2006, an indication of a change from a first TCI state to a second TCI state. The first TCI state may be associated with one or more first control channel monitoring occasions, and the second TCI state may be associated with one or more second control channel monitoring occasions different than the one or more first control channel monitoring occasions. Accordingly, the monitoring component 2008 may monitor for messages from the apparatus 2006 within the one or more second control channel monitoring occasions based at least in part on the reception component 2002 receiving the indication of the change from the first TCI state to the second TCI state. Additionally, the reception component 2002 may receive, from the apparatus 2006, a control message based at least in part on the monitoring component 2008 monitoring the one or more second control channel monitoring occasions.

In some aspects, the reception component 2002 may receive, from the apparatus 2006, an indication of an additional search space. For example, the additional search space may be a legacy search space (e.g., associated with an earlier release of 3GPP specifications than the second search space). Accordingly, the monitoring component 2008 may monitor for messages from the apparatus 2006 within the legacy search space. The messages within the legacy search space may be unicast messages, and the messages within the one or more second control channel monitoring occasions may be multicast messages.

In some aspects, the monitoring component 2008 may monitor for messages from the apparatus 2006 within the one or more first control channel monitoring occasions before the reception component 2002 receives the indication of the change from the first TCI state to the second TCI state. The monitoring component 2008 may monitor the one or more second control channel monitoring occasions in connection with a threshold time duration, after the reception component 2002 receives the indication of the change from the first TCI state to the second TCI state, being satisfied.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

FIG. 21 is a block diagram of an example apparatus 2100 for wireless communication. The apparatus 2100 may be a base station, or a base station may include the apparatus 2100. In some aspects, the apparatus 2100 includes a reception component 2102 and a transmission component 2104, which may be in communication with one another (for example, via one or more buses and/or one or more other components). As shown, the apparatus 2100 may communicate with another apparatus 2106 (such as a UE, a base station, or another wireless communication device) using the reception component 2102 and the transmission component 2104. As further shown, the apparatus 2100 may include a determination component 2108 or an encoding component 2110, among other examples.

In some aspects, the apparatus 2100 may be configured to perform one or more operations described herein in connection with FIGS. 4-11 and/or 13-21. Additionally, or alternatively, the apparatus 2100 may be configured to perform one or more processes described herein, such as process 1700 of FIG. 17, process 1900 of FIG. 19, or a combination thereof. In some aspects, the apparatus 2100 and/or one or more components shown in FIG. 21 may include one or more components of the base station described above in connection with FIG. 2. Additionally, or alternatively, one or more components shown in FIG. 21 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2102 may receive communications, such as reference signals, control information, data communications, or a combination thereof, from the apparatus 2106. The reception component 2102 may provide received communications to one or more other components of the apparatus 2100. In some aspects, the reception component 2102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2100. In some aspects, the reception component 2102 may include one or more antennas, a modem, a MIMO detector, a receive processor, a controller/processor, a memory, or a combination thereof, of the base station described above in connection with FIG. 2.

The transmission component 2104 may transmit communications, such as reference signals, control information, data communications, or a combination thereof, to the apparatus 2106. In some aspects, one or more other components of the apparatus 2100 may generate communications and may provide the generated communications to the transmission component 2104 for transmission to the apparatus 2106. In some aspects, the transmission component 2104 may perform signal processing on the generated communications (such as filtering, amplification, modulation, digital-to-analog conversion, multiplexing, interleaving, mapping, or encoding, among other examples), and may transmit the processed signals to the apparatus 2106. In some aspects, the transmission component 2104 may include one or more antennas, a modem, a transmit MIMO processor, a transmit processor, a controller/processor, a memory, or a combination thereof, of the base station described above in connection with FIG. 2. In some aspects, the transmission component 2104 may be co-located with the reception component 2102 in a transceiver.

In some aspects, the transmission component 2104 may transmit, to the apparatus 2106, an indication of a first search space for control messages from the apparatus 2100 and an indication of a first downlink beam for the first search space. Additionally, the transmission component 2104 may transmit, to the apparatus 2106, an indication of a second search space for control messages from the apparatus 2100 and an indication of a second downlink beam for the second search space. The transmission component 2104 may further send an initial transmission of data within the first search space and using the first downlink beam. The transmission component 2104 may further send a re-transmission of the data within the second search space and using the second downlink beam.

In some aspects, the transmission component 2104 may transmit, to the apparatus 2106, information activating the second search space. In some aspects, the reception component 2102 may receive, from the apparatus 2106, a signal indicating an error in decoding a message that was transmitted (e.g., by the transmission component 2104) in the first search space. Accordingly, the transmission component 2104 may transmit the information activating the second search space based at least in part on the reception component 2102 receiving the signal indicating the decoding error.

In some aspects, the determination component 2108 may determine that the second downlink beam is preferred to one or more additional downlink beams. Accordingly, the transmission component 2104 may transmit the information activating the second search space based at least in part on the determination component 2108 determining that the downlink beam is preferred to the one or more additional downlink beams. In some aspects, the determination component 2108 may include a MIMO detector, a receive processor, a modem, a transmit MIMO processor, a transmit processor, a controller/processor, a memory, or a combination thereof, of the base station described above in connection with FIG. 2.

In some aspects, the reception component 2102 may receive, from the apparatus 2106, information related to a strength of the second downlink beam. Accordingly, the transmission component 2104 may transmit the information activating the second search space based at least in part on the reception component 2102 receiving the information related to the strength of the second downlink beam.

In some aspects, the transmission component 2104 may transmit, to the apparatus 2106, an indication of a third search space for control messages from the apparatus 2100 and an indication of a third downlink beam for the third search space. The transmission component 2104 may further send a re-transmission of the data within the third search space and using the third downlink beam.

In some aspects, the reception component 2102 may receive, from the apparatus 2106, a signal indicating an error in decoding a message that was transmitted (e.g., by the transmission component 2104) in the second search space. The reception component 2102 may receive the signal indicating the decoding error on an uplink resource associated with the second search space. As an alternative, the reception component 2102 may receive the signal indicating the decoding error on an uplink resource associated with the third search space.

Additionally, or alternatively, the transmission component 2104 may transmit, to the apparatus 2106, an indication of a change from a first TCI state to a second TCI state. The first TCI state may be associated with one or more first control channel monitoring occasions, and the second TCI state may be associated with one or more second control channel monitoring occasions different than the one or more first control channel monitoring occasions. The transmission component 2104 may further transmit, to the apparatus 2106, a control message within the one or more second control channel monitoring occasions based at least in part on the transmission component 2104 transmitting the indication of the change from the first TCI state to the second TCI state.

In some aspects, the encoding component 2110 may encode a data structure defining a first search space (e.g., a SearchSpace data structure, as described herein) that provides configurations for identifying the one or more first control channel monitoring occasions and an associated data structure defining a first CORESET (e.g., a controlResourceSet data structure, as described herein). In some aspects, the encoding component 2110 may include a modem, a MIMO detector, a receive processor, a modem, a transmit MIMO processor, a transmit processor, a controller/processor, a memory, or a combination thereof, of the base station described above in connection with FIG. 2. In some aspects, the encoding component 2110 may further encode a data structure defining a second search space (e.g., a SearchSpace data structure, as described herein) that provides configurations for identifying the one or more second control channel monitoring occasions and an associated data structure defining a second CORESET (e.g., a controlResourceSet data structure, as described herein).

In some aspects, the encoding component 2110 may define the first search space and the second search space in a data structure that associates an identifier of the first TCI state (e.g., a TCI-state-ID) with the first search space and an identifier of the second TCI state (e.g., a TCI-state-ID) with the second search space. As an alternative, the encoding component 2110 may define the first TCI state and the second TCI state in a data structure (e.g., TCI-States included in a tci-StatesPDCCHToAddList data structure) that associates an identifier of the first search space with the first TCI state and an identifier of the second search space with the second TCI state.

In some aspects, the transmission component 2104 may transmit, to the apparatus 2106, an indication of an additional search space. For example, the additional search space may be a legacy search space (e.g., associated with an earlier release of 3GPP specifications than the second search space). Accordingly, the transmission component 2104 may transmit, to the apparatus 2106, another control message within the legacy search space. The control message within the legacy search space may be a unicast message, and the control message within the second search space may be a multicast message.

In some aspects, the transmission component 2104 may transmit the control message within the one or more first control channel monitoring occasions before the transmission component 2104 transmits the indication of the change from the first TCI state to the second TCI state. Accordingly, the transmission component 2104 may transmit the control message within the one or more second control channel monitoring occasions in connection with a threshold time duration, after the transmission component 2104 transmits the indication of the change from the first TCI state to the second TCI state, being satisfied.

The number and arrangement of components shown in FIG. 21 are provided as an example. In practice, there may be additional components, fewer components, different components, or differently arranged components than those shown in FIG. 21. Furthermore, two or more components shown in FIG. 21 may be implemented within a single component, or a single component shown in FIG. 21 may be implemented as multiple, distributed components. Additionally, or alternatively, a set of (one or more) components shown in FIG. 21 may perform one or more functions described as being performed by another set of components shown in FIG. 21.

The following provides an overview of some Aspects of the present disclosure:

Aspect 1: A method of wireless communication performed by a user equipment (UE), comprising: receiving, from a base station, an indication of a first search space for control messages from the base station and an indication of a first downlink beam for the first search space; receiving, from the base station, an indication of a second search space for control messages from the base station and an indication of a second downlink beam for the second search space; monitoring the first search space, using a spatial filter based at least in part on the first downlink beam, for an initial transmission of data from the base station; and monitoring the second search space, using a spatial filter based at least in part on the second downlink beam, for re-transmission of the data from the base station.

Aspect 2: The method of Aspect 1, wherein the first downlink beam is associated with a first transmission configuration indicator (TCI) state, and the second downlink beam is associated with a second TCI state.

Aspect 3: The method of any of Aspects 1 through 2, wherein the first search space is associated with a first control resource set (CORESET), and the second search space is associated with a second CORESET.

Aspect 4: The method of any of Aspects 1 through 3, wherein the first search space is a search space common to a group of UEs including the UE.

Aspect 5: The method of Aspect 4, wherein the first search space is monitored for downlink control information (DCI) scrambled with a group identifier associated with the group of UEs including the UE.

Aspect 6: The method of any of Aspects 1 through 5, wherein the second search space is a search space common to a group of UEs including the UE.

Aspect 7: The method of Aspect 6, wherein the second search space is monitored for downlink control information (DCI) scrambled with a group identifier associated with the group of UEs including the UE.

Aspect 8: The method of any of Aspects 1 through 5, wherein the second search space is a search space specific to the UE.

Aspect 9: The method of Aspect 8, wherein the second search space is monitored for downlink control information (DCI) scrambled with a specific identifier associated with the UE.

Aspect 10: The method of any of Aspects 1 through 9, further comprising: detecting an error when attempting to decode a message that was received while monitoring the first search space, wherein the second search space is monitored based at least in part on detecting the decoding error.

Aspect 11: The method of any of Aspects 1 through 9, further comprising: receiving, from the base station, information activating the second search space, wherein the second search space is monitored based at least in part on receiving the information activating the second search space.

Aspect 12: The method of Aspect 11, wherein the information activating the second search space includes at least one of a medium access control (MAC) layer control element (MAC-CE) or downlink control information (DCI).

Aspect 13: The method of any of Aspects 11 through 12, further comprising: detecting an error when attempting to decode a message that was received while monitoring the first search space; and transmitting, to the base station, a signal indicating the decoding error, wherein the information activating the second search space is received based at least in part on transmitting the signal indicating the decoding error.

Aspect 14: The method of any of Aspects 1 through 13, further comprising: determining that the second downlink beam is preferred to one or more additional downlink beams, wherein the second search space is monitored based at least in part on determining that the second downlink beam is preferred to the one or more additional downlink beams.

Aspect 15: The method of Aspect 14, wherein determining that the second downlink beam is preferred to the one or more additional downlink beams is based at least in part on a signal strength of the second downlink beam, an interference strength of the second downlink beam, or a quality indicator associated with the second downlink beam.

Aspect 16: The method of any of Aspects 14 through 15, further comprising: detecting an error when attempting to decode a message that was received while monitoring the first search space; and transmitting, to the base station, information related to a strength of the second downlink beam, wherein monitoring the second search space is performed in connection with transmitting the information related to the strength of the second downlink beam.

Aspect 17: The method of any of Aspects 1 through 16, wherein the indication of the first search space comprises a data structure that includes a list of associated transmission configuration indicator (TCI) states that include a TCI state for the first downlink beam.

Aspect 18: The method of any of Aspects 1 through 16, wherein the indication of the first search space comprises a data structure that includes an identifier, wherein the identifier is associated with one or more transmission configuration indicator (TCI) states that include a TCI state for the first downlink beam.

Aspect 19: The method of any of Aspects 1 through 18, further comprising: decoding a message from the base station by soft-combining a signal scheduled by downlink control information (DCI) received in the first search space with an additional signal scheduled by DCI received in the second search space.

Aspect 20: The method of any of Aspects 1 through 18, further comprising: receiving, from the base station, an indication of a third search space for control messages from the base station and an indication of a third downlink beam for the third search space; monitoring the third search space, using a spatial filter based at least in part on the third downlink beam, for a re-transmission of the data from the base station; and decoding a message from the base station by soft-combining a signal scheduled by downlink control information (DCI) received in the second search space with an additional signal scheduled by DCI received in the third search space.

Aspect 21: The method of any of Aspects 1 through 20, further comprising: detecting an error when attempting to decode a message that was received while monitoring the second search space; and transmitting, to the base station, a signal indicating the decoding error, wherein the signal indicating the decoding error is transmitted on an uplink resource associated with the second search space.

Aspect 22: The method of any of Aspects 1 through 20, further comprising: receiving, from the base station, an indication of a third search space for control messages from the base station and an indication of a third downlink beam for the third search space; detecting an error when attempting to decode a message that was received while monitoring the second search space; and transmitting, to the base station, a signal indicating the decoding error, wherein the signal indicating the decoding error is transmitted on an uplink resource associated with the third search space.

Aspect 23: A method of wireless communication performed by a base station, comprising: transmitting, to a user equipment (UE), an indication of a first search space for control messages from the base station and an indication of a first downlink beam for the first search space; transmitting, to the UE, an indication of a second search space for control messages from the base station and an indication of a second downlink beam for the second search space; sending an initial transmission of data within the first search space and using the first downlink beam; and sending a re-transmission of the data within the second search space and using the second downlink beam.

Aspect 24: The method of Aspect 23, wherein the first downlink beam is associated with a first transmission configuration indicator (TCI) state, and the second downlink beam is associated with a second TCI state.

Aspect 25: The method of any of Aspects 23 through 24, wherein the first search space is associated with a first control resource set (CORESET), and the second search space is associated with a second control resource set (CORESET).

Aspect 26: The method of any of Aspects 23 through 25, wherein the first search space is a search space common to a group of UEs including the UE.

Aspect 27: The method of Aspect 26, wherein the initial transmission is scheduled by transmitting, in the first search space, downlink control information (DCI) scrambled with a group identifier associated with the group of UEs including the UE.

Aspect 28: The method of any of Aspects 23 through 27, wherein the second search space is a search space common to a group of UEs including the UE.

Aspect 29: The method of Aspect 28, wherein the re-transmission is scheduled by transmitting, in the second search space, downlink control information (DCI) scrambled with a group identifier associated with the group of UEs including the UE.

Aspect 30: The method of any of Aspects 23 through 27, wherein the second search space is a search space specific to the UE.

Aspect 31: The method of Aspect 30, wherein the re-transmission is scheduled by transmitting, in the second search space, downlink control information (DCI) scrambled with a specific identifier associated with the UE.

Aspect 32: The method of any of Aspects 23 through 31, further comprising: transmitting, to the UE, information activating the second search space.

Aspect 33: The method of Aspect 32, wherein the information activating the second search space includes at least one of a medium access control (MAC) layer control element (MAC-CE) or downlink control information (DCI).

Aspect 34: The method of any of Aspects 32 through 33, further comprising: receiving, from the UE, a signal indicating an error in decoding a message that was transmitted in the first search space, wherein the information activating the second search space is transmitted based at least in part on receiving the signal indicating the decoding error.

Aspect 35: The method of any of Aspects 32 through 34, further comprising: determining that the second downlink beam is preferred to one or more additional downlink beams, wherein the information activating the second search space is transmitted based at least in part on determining that the second downlink beam is preferred to the one or more additional downlink beams.

Aspect 36: The method of Aspect 35, wherein determining that the second downlink beam is preferred to the one or more additional downlink beams is based at least in part on a signal strength of the second downlink beam, an interference strength of the second downlink beam, or a quality indicator associated with the second downlink beam.

Aspect 37: The method of any of Aspects 32 through 36, further comprising: receiving, from the UE, information related to a strength of the second downlink beam, wherein the information activating the second search space is transmitted based at least in part on receiving the information related to the strength of the second downlink beam.

Aspect 38: The method of any of Aspects 23 through 37, wherein the indication of the first search space comprises a data structure that includes a list of associated transmission configuration indicator (TCI) states that include a TCI state for the first downlink beam.

Aspect 39: The method of any of Aspects 23 through 37, wherein the indication of the first search space comprises a data structure that includes an identifier, wherein the identifier is associated with one or more transmission configuration indicator (TCI) states that include a TCI state for the first downlink beam.

Aspect 40: The method of any of Aspects 23 through 39, further comprising: transmitting, to the UE, an indication of a third search space for control messages from the base station and an indication of a third downlink beam for the third search space; and sending a re-transmission of the data within the third search space and using the third downlink beam.

Aspect 41: The method of any of Aspects 23 through 40, further comprising: receiving, from the UE, a signal indicating an error in decoding a message that was transmitted in the second search space, wherein the signal indicating the decoding error is received on an uplink resource associated with the second search space.

Aspect 42: The method of any of Aspects 23 through 40, further comprising: transmitting, to the UE, an indication of a third search space for control messages from the base station and an indication of a third downlink beam for the third search space; and receiving, from the UE, a signal indicating an error in decoding a message that was transmitted in the second search space, wherein the signal indicating the decoding error is received on an uplink resource associated with the third search space.

Aspect 43: A method of wireless communication performed by a user equipment (UE), comprising: receiving, from a base station, an indication of a change from a first transmission configuration indicator (TCI) state to a second TCI state, wherein the first TCI state is associated with one or more first control channel monitoring occasions, and the second TCI state is associated with one or more second control channel monitoring occasions different than the one or more first control channel monitoring occasions; monitoring for messages from the base station within the one or more second control channel monitoring occasions based at least in part on receiving the indication of the change from the first TCI state to the second TCI state; and receiving, from the base station, a control message based at least in part on monitoring the one or more second control channel monitoring occasions.

Aspect 44: The method of Aspect 43, wherein a first search space that provides configurations for identifying the one or more first control channel monitoring occasions is associated with a first control resource set (CORESET), and a second search space that provides configurations for identifying the one or more second control channel monitoring occasions is associated with a second CORESET.

Aspect 45: The method of Aspect 44, wherein the first search space and the second search space are defined in a data structure that associates an identifier of the first TCI state with the first search space and an identifier of the second TCI state with the second search space.

Aspect 46: The method of Aspect 44, wherein the first TCI state and the second TCI state are defined in a data structure that associates an identifier of the first search space with the first TCI state and an identifier of the second search space with the second TCI state.

Aspect 47: The method of any of Aspects 43 through 46, further comprising: receiving, from the base station, an indication of an additional search space; and monitoring for messages from the base station within the additional search space, wherein the messages within the additional search space are unicast messages, and the messages within the one or more second control channel monitoring occasions are multicast messages.

Aspect 48: The method of Aspect 47, wherein the additional search space or the one or more second control channel monitoring occasions are monitored based at least in part on applying one or more stored rules.

Aspect 49: The method of any of Aspects 47 through 48, wherein the additional search space and the one or more second control channel monitoring occasions share a source reference signal, and both the one or more second control channel monitoring occasions and the additional search space are monitored.

Aspect 50: The method of any of Aspects 47 through 49, wherein the unicast messages are time division multiplexed with the multicast messages.

Aspect 51: The method of any of Aspects 47 through 49, wherein the unicast messages are frequency division multiplexed with the multicast messages.

Aspect 52: The method of any of Aspects 47 through 51, wherein monitoring for messages from the base station within the one or more second control channel monitoring occasions comprises monitoring for messages from the base station within a portion of candidates that are included in the one or more second control channel monitoring occasions.

Aspect 53: The method of Aspect 52, wherein the portion of candidates included in the one or more second control channel monitoring occasions that are monitored are selected based at least in part on candidates that are included in all search spaces across all possible TCI states.

Aspect 54: The method of Aspect 52, wherein the portion of candidates included in the one or more second control channel monitoring occasions that are monitored are selected based at least in part on candidates that are included in all search spaces associated with the second TCI state.

Aspect 55: The method of Aspect 52, wherein the portion of candidates included in the one or more second control channel monitoring occasions that are monitored are selected based at least in part on a largest number of candidates that are included in a span and that are largest amongst all possible TCI states associated with the span.

Aspect 56: The method of any of Aspects 43 through 55, further comprising: monitoring for messages from the base station within the one or more first control channel monitoring occasions before receiving the indication of the change from the first TCI state to the second TCI state, wherein the one or more second control channel monitoring occasions are monitored in connection with a threshold time duration, after receiving the indication of the change from the first TCI state to the second TCI state, being satisfied.

Aspect 57: The method of any of Aspects 43 through 56, wherein the UE is in an idle mode or an inactive state, the one or more second control channel monitoring occasions are associated with a source reference signal, and the one or more second control channel monitoring occasions are monitored based at least in part on a strength of the source reference signal.

Aspect 58: A method of wireless communication performed by a base station, comprising: transmitting, to a user equipment (UE), an indication of a change from a first transmission configuration indicator (TCI) state to a second TCI state, wherein the first TCI state is associated with one or more first control channel monitoring occasions, and the second TCI state is associated with one or more second control channel monitoring occasions different than the one or more first control channel monitoring occasions; and transmitting, to the UE, a control message within the one or more second control channel monitoring occasions based at least in part on transmitting the indication of the change from the first TCI state to the second TCI state.

Aspect 59: The method of Aspect 58, wherein a first search space that provides configurations for identifying the one or more first control channel monitoring occasions is associated with a first control resource set (CORESET), and a second search space that provides configurations for identifying the one or more second control channel monitoring occasions is associated with a second CORESET.

Aspect 60: The method of Aspect 59, wherein the first search space and the second search space are defined in a data structure that associates an identifier of the first TCI state with the first search space and an identifier of the second TCI state with the second search space.

Aspect 61: The method of Aspect 59, wherein the first TCI state and the second TCI state are defined in a data structure that associates an identifier of the first search space with the first TCI state and an identifier of the second search space with the second TCI state.

Aspect 62: The method of any of Aspects 58 through 61, further comprising: transmitting, to the UE, an indication of an additional search space; and transmitting, to the UE, another control message within the additional search space, wherein the control message within the additional search space is a unicast message, and the control message within the one or more second control channel monitoring occasions is a multicast message.

Aspect 63: The method of Aspect 62, wherein the one or more second control channel monitoring occasions and the additional search space share a source reference signal.

Aspect 64: The method of any of Aspects 62 through 63, wherein the unicast message is time division multiplexed with the multicast message.

Aspect 65: The method of any of Aspects 62 through 63, wherein the unicast message is frequency division multiplexed with the multicast message.

Aspect 66: The method of any of Aspects 58 through 65, wherein transmitting the control message within the one or more second control channel monitoring occasions comprises transmitting the control message within a portion of candidates that are included in the one or more second control channel monitoring occasions.

Aspect 67: The method of Aspect 66, wherein the portion of candidates included in the one or more second control channel monitoring occasions that are monitored are selected based at least in part on candidates that are included in all search spaces across all possible TCI states.

Aspect 68: The method of Aspect 66, wherein the portion of candidates included in the one or more second control channel monitoring occasions that are monitored are selected based at least in part on candidates that are included in all search spaces associated with the second TCI state.

Aspect 69: The method of Aspect 66, wherein the portion of candidates included in the one or more second control channel monitoring occasions that are monitored are selected based at least in part on a largest number of candidates that are included in a span and that are largest amongst all possible TCI states associated with the span.

Aspect 70: The method of any of Aspects 58 through 69, further comprising: transmitting the control message within the one or more first control channel monitoring occasions before transmitting the indication of the change from the first TCI state to the second TCI state, wherein the control message is transmitted within the one or more second control channel monitoring occasions in connection with a threshold time duration, after transmitting the indication of the change from the first TCI state to the second TCI state, being satisfied.

Aspect 71: An apparatus for wireless communication at a device, comprising a processor; memory coupled with the processor; and instructions stored in the memory and executable by the processor to cause the apparatus to perform the method of one or more of Aspects 1-22.

Aspect 72: A device for wireless communication, comprising a memory and one or more processors coupled to the memory, the one or more processors configured to perform the method of one or more of Aspects 1-22.

Aspect 73: An apparatus for wireless communication, comprising at least one means for performing the method of one or more of Aspects 1-22.

Aspect 74: A non-transitory computer-readable medium storing code for wireless communication, the code comprising instructions executable by a processor to perform the method of one or more of Aspects 1-22.

Aspect 75: A non-transitory computer-readable medium storing a set of instructions for wireless communication, the set of instructions comprising one or more instructions that, when executed by one or more processors of a device, cause the device to perform the method of one or more of Aspects 1-22.

Aspect 76: An apparatus for wireless communication at a device, comprising a processor; memory coupled with the processor; and instructions stored in the memory and executable by the processor to cause the apparatus to perform the method of one or more of Aspects 23-42.

Aspect 77: A device for wireless communication, comprising a memory and one or more processors coupled to the memory, the one or more processors configured to perform the method of one or more of Aspects 23-42.

Aspect 78: An apparatus for wireless communication, comprising at least one means for performing the method of one or more of Aspects 23-42.

Aspect 79: A non-transitory computer-readable medium storing code for wireless communication, the code comprising instructions executable by a processor to perform the method of one or more of Aspects 23-42.

Aspect 80: A non-transitory computer-readable medium storing a set of instructions for wireless communication, the set of instructions comprising one or more instructions that, when executed by one or more processors of a device, cause the device to perform the method of one or more of Aspects 23-42.

Aspect 81: An apparatus for wireless communication at a device, comprising a processor; memory coupled with the processor; and instructions stored in the memory and executable by the processor to cause the apparatus to perform the method of one or more of Aspects 43-57.

Aspect 82: A device for wireless communication, comprising a memory and one or more processors coupled to the memory, the one or more processors configured to perform the method of one or more of Aspects 43-57.

Aspect 83: An apparatus for wireless communication, comprising at least one means for performing the method of one or more of Aspects 43-57.

Aspect 84: A non-transitory computer-readable medium storing code for wireless communication, the code comprising instructions executable by a processor to perform the method of one or more of Aspects 43-57.

Aspect 85: A non-transitory computer-readable medium storing a set of instructions for wireless communication, the set of instructions comprising one or more instructions that, when executed by one or more processors of a device, cause the device to perform the method of one or more of Aspects 43-57.

Aspect 86: An apparatus for wireless communication at a device, comprising a processor; memory coupled with the processor; and instructions stored in the memory and executable by the processor to cause the apparatus to perform the method of one or more of Aspects 58-70.

Aspect 87: A device for wireless communication, comprising a memory and one or more processors coupled to the memory, the one or more processors configured to perform the method of one or more of Aspects 58-70.

Aspect 88: An apparatus for wireless communication, comprising at least one means for performing the method of one or more of Aspects 58-70.

Aspect 89: A non-transitory computer-readable medium storing code for wireless communication, the code comprising instructions executable by a processor to perform the method of one or more of Aspects 58-70.

Aspect 90: A non-transitory computer-readable medium storing a set of instructions for wireless communication, the set of instructions comprising one or more instructions that, when executed by one or more processors of a device, cause the device to perform the method of one or more of Aspects 58-70.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a base station, an indication of a first search space for control messages from the base station and an indication of a first downlink beam for the first search space;
receive, from the base station, an indication of a second search space for control messages from the base station and an indication of a second downlink beam for the second search space;
monitor the first search space, using a spatial filter based at least in part on the first downlink beam, for an initial transmission of data from the base station; and
monitor the second search space, using a spatial filter based at least in part on the second downlink beam, for a re-transmission of the data from the base station.

2. The apparatus of claim 1, wherein the first downlink beam is associated with a first transmission configuration indicator (TCI) state, and the second downlink beam is associated with a second TCI state.

3. The apparatus of claim 1, wherein the first search space is associated with a first control resource set (CORESET), and the second search space is associated with a second CORESET.

4. The apparatus of claim 1, wherein the first search space is monitored for downlink control information (DCI) scrambled with a group identifier associated with a group of UEs including the UE.

5. The apparatus of claim 1, wherein the second search space is monitored for downlink control information (DCI) scrambled with a group identifier associated with a group of UEs including the UE or for DCI scrambled with a specific identifier associated with the UE.

6. The apparatus of claim 1, wherein the one or more processors are further configured to:
detect an error when attempting to decode a message that was received while monitoring the first search space,
wherein monitoring the second search space is based at least in part on detecting the decoding error.

7. The apparatus of claim 1, wherein the one or more processors are further configured to:
receive, from the base station, information activating the second search space,
wherein monitoring the second search space is based at least in part on the information activating the second search space.

8. The apparatus of claim 7, wherein the one or more processors are further configured to:
detect an error when attempting to decode a message that was received while monitoring the first search space; and
transmit, to the base station, a signal indicating the decoding error,
wherein the information activating the second search space is received based at least in part on the signal indicating the decoding error.

9. The apparatus of claim 1, wherein the one or more processors are further configured to:
determine that the second downlink beam is preferred to one or more additional downlink beams,
wherein the second search space is monitored based at least in part on the second downlink beam being determined to be preferred to the one or more additional downlink beams.

10. The apparatus of claim 9, wherein the second downlink beam is determined to be preferred to the one or more additional downlink beams based at least in part on a signal strength of the second downlink beam, an interference strength of the second downlink beam, or a quality indicator associated with the second downlink beam.

11. The apparatus of claim 9, wherein the one or more processors are further configured to:
detect an error when attempting to decode a message that was received while monitoring the first search space; and
transmit, to the base station, information related to a strength of the second downlink beam,
wherein the second search space is monitored in connection with the information, related to the strength of the second downlink beam, being transmitted.

12. The apparatus of claim 1, wherein the indication of the first search space comprises a data structure that includes a list of associated transmission configuration indicator (TCI) states that include a TCI state for the first downlink beam.

13. The apparatus of claim 1, wherein the indication of the first search space comprises a data structure that includes an identifier, wherein the identifier is associated with one or more transmission configuration indicator (TCI) states that include a TCI state for the first downlink beam.

14. The apparatus of claim 1, wherein the one or more processors are further configured to:
decode a message from the base station by soft-combining a signal scheduled by downlink control information (DCI) received in the first search space with an additional signal scheduled by DCI received in the second search space.

15. The apparatus of claim 1, wherein the one or more processors are further configured to:
receive, from the base station, an indication of a third search space for control messages from the base station and an indication of a third downlink beam for the third search space;
monitor the third search space, using a spatial filter based at least in part on the third downlink beam, for a re-transmission of the data from the base station; and
decoding a message from the base station by soft-combining a signal scheduled by downlink control information (DCI) received in the second search space with an additional signal scheduled by DCI received in the third search space.

16. The apparatus of claim 1, wherein the one or more processors are further configured to:
detect an error when attempting to decode a message that was received while monitoring the second search space; and
transmit, to the base station, a signal indicating the decoding error,
wherein the signal indicating the decoding error is transmitted on an uplink resource associated with the second search space.

17. The apparatus of claim 1, wherein the one or more processors are further configured to:
receive, from the base station, an indication of a third search space for control messages from the base station and an indication of a third downlink beam for the third search space;
detect an error when attempting to decode a message that was received while monitoring the second search space; and
transmit, to the base station, a signal indicating the decoding error,
wherein the signal indicating the decoding error is transmitted on an uplink resource associated with the third search space.

18. An apparatus for wireless communication at a base station, comprising:
a memory; and
one or more processors, coupled to the memory, configured to:
transmit, to a user equipment (UE), an indication of a first search space for control messages from the base station and an indication of a first downlink beam for the first search space;
transmit, to the UE, an indication of a second search space for control messages from the base station and an indication of a second downlink beam for the second search space;
send an initial transmission of data within the first search space and using the first downlink beam; and
send a re-transmission of the data within the second search space and using the second downlink beam.

19. An apparatus for wireless communication at a user equipment (UE), comprising:
a memory; and
one or more processors, coupled to the memory, configured to:
receive, from a base station, an indication of a change from a first transmission configuration indicator (TCI) state to a second TCI state, wherein the first TCI state is associated with one or more first control channel monitoring occasions, and the second TCI state is associated with one or more second control channel monitoring occasions different than the one or more first control channel monitoring occasions;
monitor for messages from the base station within the one or more second control channel monitoring occasions based at least in part on the indication of the change from the first TCI state to the second TCI state; and
receive, from the base station, a control message based at least in part on the one or more second control channel monitoring occasions being monitored.

20. The apparatus of claim 19, wherein a first search space that provides configurations for identifying the one or more first control channel monitoring occasions is associated with a first control resource set (CORESET), and a second search space that provides configurations for identifying the one or more second control channel monitoring occasions is associated with a second CORESET.

21. The apparatus of claim 20, wherein the first search space and the second search space are defined in a data structure that associates an identifier of the first TCI state with the first search space and an identifier of the second TCI state with the second search space.

22. The apparatus of claim 20, wherein the first TCI state and the second TCI state are defined in a data structure that associates an identifier of the first search space with the first TCI state and an identifier of the second search space with the second TCI state.

23. The apparatus of claim 19, wherein the one or more processors are further configured to:
receive, from the base station, an indication of an additional search space; and
monitor for messages from the base station within the additional search space,
wherein the messages within the additional search space are unicast messages, and the messages within the one or more second control channel monitoring occasions are multicast messages.

24. The apparatus of claim 23, wherein the additional search space and the one or more second control channel monitoring occasions share a source reference signal, and both the one or more second control channel monitoring occasions and the additional search space are monitored.

25. The apparatus of claim 19, wherein the one or more processors, to monitor for messages from the base station within the one or more second control channel monitoring occasions, ae configured to monitor for messages from the base station within a portion of candidates that are included in the one or more second control channel monitoring occasions.

26. The apparatus of claim 25, wherein the portion of candidates included in the one or more second control channel monitoring occasions that are monitored are selected based at least in part on candidates that are included in all search spaces across all possible TCI states.

27. The apparatus of claim 25, wherein the portion of candidates included in the one or more second control channel monitoring occasions that are monitored are selected based at least in part on candidates that are included in all search spaces associated with the second TCI state.

28. The apparatus of claim 25, wherein the portion of candidates included in the one or more second control channel monitoring occasions that are monitored are selected based at least in part on a largest number of candidates that are included in a span and that are largest amongst all possible TCI states associated with the span.

29. The apparatus of claim 19, wherein the one or more processors are further configured to:
monitor for messages from the base station within the one or more first control channel monitoring occasions before receiving the indication of the change from the first TCI state to the second TCI state,
wherein the one or more second control channel monitoring occasions are monitored in connection with a threshold time duration, after receiving the indication of the change from the first TCI state to the second TCI state, being satisfied.

30. An apparatus for wireless communication at a base station, comprising:
a memory; and
one or more processors, coupled to the memory, configured to:
transmit, to a user equipment (UE), an indication of a change from a first transmission configuration indicator (TCI) state to a second TCI state, wherein the first TCI state is associated with one or more first control channel monitoring occasions, and the second TCI state is associated with one or more second control channel monitoring occasions different than the one or more first control channel monitoring occasions; and
transmit, to the UE, a control message within the one or more second control channel monitoring occasions based at least in part on the indication of the change from the first TCI state to the second TCI state.
